(19) United States
(12) Patent Application Publication
(10) Pub. No.: US 2024/0265338 A1
(43) Pub. Date: Aug. 8, 2024

(54) RANDOM-WALK BASED VEHICLE ROUTING PROBLEM (VRP) PARTITIONING FOR ANNEALER-BASED SOLUTION

(71) Applicant: Fujitsu Limited, Kawasaki-shi, Kanagawa (JP)

(72) Inventors: Hayato USHIJIMA-MWESIGWA, Dublin, CA (US); Hanjing XU, Lafayette, IN (US); Indradeep GHOSH, Cupertino, CA (US)

(73) Assignee: Fujitsu Limited, Kawasaki-shi, Kanagawa (JP)

(21) Appl. No.: 18/164,598

(22) Filed: Feb. 5, 2023

(51) Int. Cl. G06Q 10/0835

(52) U.S. Cl. CPC G06Q 10/08355

(57) ABSTRACT

In an embodiment, a set of constraints associated with a vehicle routing problem is received. The vehicle routing problem is an optimization problem whose goal is to determine a set of optimal routes, between a depot and a set of customers, for a delivery of a set of items using a set of vehicles, and a total cost associated with the set of optimal routes corresponds to a minimum cost. The optimization problem is constructed. A random-walk graph. A graph partitioner is applied on the constructed random-walk graph. The set of customers is clustered. The constructed optimization problem is split into a set of sub-problems. An intermediate solution for each of the set of sub-problems is determined. The determined intermediate solution associated with each of the set of sub-problems is combined to determine a final solution. The determined final solution is rendered on a display device.

### FIELD

The embodiments discussed in the present disclosure are related to random-walk based vehicle routing problem (VRP) partitioning for annealer-based solution.

### BACKGROUND

Advancements in the field of operational research have led to optimization of various industrial processes, such as, production lines, raw material transportation, product distribution, supply-chain related processes, and the like. With the growing complexity of the industrial processes, the optimization of such processes has become a non-trivial task. For example, each industrial process may have several constraints, which may have to be satisfied together during the optimization of the process. An example of an optimization problem of an industrial process is a vehicle routing problem. The goal of the vehicle routing problem is to determine optimal routes for a set of vehicles to distribute items between a depot and a set of customers. Traditional methods for optimization of the industrial processes may require significant time and computing resources. The vehicle routing problem may be a challenging optimization problem with many important applications in the transportation industry. There may be a number of different variants of the VRP arising from different application specific constraints. In practice, a specialized solver may be created for each specific VRP application. However, such solvers may generally have difficulties for scaling to larger problems due to the NP-hard nature of the vehicle routing problem. That is, current VRP instances may be too large and complex to solve based on state-of-the art or near-term hardware. Traditional methods may require significant time and computational resources to optimize the industrial processes. Thus, there is a need for efficient techniques for optimization of the industrial processes.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include a set of operations, which may include receiving a set of constraints associated with a vehicle routing problem, wherein the vehicle routing problem may be an optimization problem whose goal may be to determine a set of optimal routes, between a depot and a set of customers, for a delivery of a set of items using a set of vehicles, and a total cost associated with the set of optimal routes may correspond to a minimum cost associated with a set of possible routes between the depot and the set of customers. The set of operations may further include constructing the optimization problem based on the received set of constraints. The set of operations may further include constructing a random-walk graph based on the constructed optimization problem and the received set of constraints. The set of operations may further include applying a graph partitioner on the constructed random-walk graph. The set of operations may further include clustering the set of customers based on the application of the graph partitioner on the constructed random-walk graph. The set of operations may further include splitting the constructed optimization problem into a set of sub-problems, based on the clustering of the set of customers. The set of operations may further include determining, using an annealer-based solver, an intermediate solution for each of the set of sub-problems to determine a set of routes associated with the corresponding sub-problem of the set of sub-problems. The set of operations may further include combining the determined intermediate solution associated with each of the set of sub-problems to determine a final solution of the optimization problem based on the received set of constraints, wherein the determined final solution may be indicative of the set of optimal routes to be assigned to the set of vehicles. The set of operations may further include rendering the determined final solution of the optimization problem on a display device.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to a random-walk based vehicle routing problem (VRP) partitioning for annealer-based solution;

FIG. 2 is a block diagram that illustrates an exemplary electronic device for the random-walk based vehicle routing problem (VRP) partitioning for annealer-based solution;

FIG. 3 is a diagram that illustrates a flowchart of an example method for random-walk based vehicle routing problem (VRP) partitioning for annealer-based solution;

FIG. 4 is a diagram that illustrates an exemplary scenario for random-walk based vehicle routing problem (VRP) partitioning for annealer-based solution;

FIG. 5A is a diagram that illustrates a vehicle routing problem corresponding to a traveling salesman problem;

FIG. 5B is a diagram that illustrates a vehicle routing problem corresponding to a capacitated vehicle routing problem;

FIG. 5C is a diagram that illustrates a vehicle routing problem with time-windows;

FIG. 5D is a diagram that illustrates a vehicle routing problem with pickup and delivery time-windows;

FIGS. 6A and 6B are diagrams that illustrates an execution pipeline for the random-walk based vehicle routing problem (VRP) partitioning for annealer-based solution;

FIG. 7 is a diagram that illustrates flowchart of an example method for obtaining a random-walk graph;

FIG. 8 is a diagram that illustrates a flowchart of an example method for a determination of a pre-defined probability distribution; and

FIG. 9 is a diagram that illustrate an exemplary scenario of a random walk graph;

all according to at least one embodiment described in the present disclosure.

### DESCRIPTION OF EMBODIMENTS

Some embodiments described in the present disclosure relate to methods and systems for random-walk based vehicle routing problem (VRP) partitioning for annealer-based solution. In the present disclosure, a set of constraints associated with a vehicle routing problem may be received. The vehicle routing problem may be an optimization problem whose goal may be to determine a set of optimal routes, between a depot and a set of customers, for a delivery of a set of items using a set of vehicles, and a total cost associated with the set of optimal routes may correspond to a minimum cost associated with a set of possible routes between the depot and the set of customers. Further, the optimization problem may be constructed based on the received set of constraints. Further, a random-walk graph may be constructed based on the constructed optimization problem and the received set of constraints. Further, a graph partitioner may be applied on the constructed random-walk graph. Further, the set of customers may be clustered based on the application of the graph partitioner on the constructed random-walk graph. Further, the constructed optimization problem may be split into a set of sub-problems, based on the clustering of the set of customers. Thereafter, an intermediate solution for each of the set of sub-problems may be determined using an annealer-based solver to determine a set of routes associated with the corresponding sub-problem of the set of sub-problems. Thereafter, the determined intermediate solution associated with each of the set of sub-problems may be combined to determine a final solution of the optimization problem based on the received set of constraints, wherein the determined final solution may be indicative of the set of optimal routes to be assigned to the set of vehicles. Further, the determined final solution of the optimization problem may be rendered on a display device.

According to one or more embodiments of the present disclosure, the technological field of operational research may be improved by configuring a computing system in a manner that the computing system may be able to partition random-walk based vehicle routing problem (VRP) for annealer-based solution. The computing system may receive a set of constraints associated with a vehicle routing problem, wherein the vehicle routing problem may be an optimization problem whose goal may be to determine a set of optimal routes, between a depot and a set of customers, for a delivery of a set of items using a set of vehicles, and a total cost associated with the set of optimal routes may correspond to a minimum cost associated with a set of possible routes between the depot and the set of customers. Next, the computing system may construct the optimization problem based on the received set of constraints. Thereafter, the computing system may construct a random-walk graph based on the constructed optimization problem and the received set of constraints. Thereafter, the computing system may apply a graph partitioner on the constructed random-walk graph. Thereafter, the computing system may cluster the set of customers based on the application of the graph partitioner on the constructed random-walk graph. Further, the computing system may split the constructed optimization problem into a set of sub-problems, based on the clustering of the set of customers. Further, the computing system may determine, using an annealer-based solver, an intermediate solution for each of the set of sub-problems to determine a set of routes associated with the corresponding sub-problem of the set of sub-problems. Further, the computing system may combine the determined intermediate solution associated with each of the set of sub-problems to determine a final solution of the optimization problem based on the received set of constraints, wherein the determined final solution may be indicative of the set of optimal routes to be assigned to the set of vehicles. Further, the computing system may render the determined final solution of the optimization problem on a display device.

The vehicle routing problem (VRP) may be a routing problem for determining an optimal set of routes for a set of vehicles. The vehicle routing problem may be a challenging optimization problem with many important applications in the transportation industry. There may be a number of different variants of the VRP arising from different application specific constraints. In practice, a specialized solver may be created for each specific VRP application. However, such solvers may generally have difficulties for scaling to larger problems due to the NP-hard nature of the vehicle routing problem. That is, current VRP instances may be too large and complex to solve based on state-of-the art or near-term hardware. Traditional methods may require significant time and computational resources to optimize the industrial processes.

The present disclosure provides a decomposition technique for partitioning a VRP problem into multiple smaller problems that may be solved individually. The decomposition technique may create a large problem which may be then partitioned and solved with quantum-inspired solvers that may be known to give good solutions for such problems. That is, the disclosed computing device (e.g., an electronic device) may solve complex VRP optimization problems using multiple annealer-based solvers based on the decomposition of the VRP optimization problem into sub-problems. The set of sub-problems may be determined based on the clustering of the set of customers. The clustering the set of customers may be determined based on the application of the graph partitioner on the constructed random-walk graph. Typically, K-means clustering may be widely used for VRP, wherein the set of customers may be grouped into K clusters with respect to geographical distances. Multiple heuristics may exist for K-means clustering technique, but such approaches may be hard to generalize for different variants of VRPs. The present disclosure provides a random-walk based graph partitioning approach to simplify the design of clustering techniques on different VRP variants. For example, the random-walk based graph partitioning approach may cluster a capacitated vehicle routing problem that may allow each cluster to be handled by one vehicle so that total demands for the customers may not exceed vehicle's capacity. The random-walk based graph partitioning approach may cluster a capacitated vehicle routing problem with time-windows, wherein the clustering may be based not only on the geographical distances as nearby customers may have wide time window differences and vehicles may have to wait for a long time if a pair of customer wants to be served consecutively. The random-walk based graph partitioning approach may cluster a capacitated vehicle routing problem having pickup and delivery with time-windows, wherein the customers who have pickup and delivery requests may be put in the same cluster to have their demands satisfied. The present disclosure may find clusters for complex VRP by easily generalized to VRP variants. Further, in some embodiments, the present disclosure may also consider both distance and angle while clustering the set of customers. The random-walk graph based VRP partitioning and annealer-based solution approach of the disclosure may be simpler and more efficient than typical approaches and may also be easily generalized to various types of VRP variants. Thus, the disclosed random-walk graph based approach may provide optimal solutions for various types of VRP variants, which when implemented for corresponding industrial processes may result in lesser loss in revenue, wastage of time, and requirement of additional man-hours of effort, as compared to traditional approaches.

Embodiments of the present disclosure are explained with reference to the accompanying drawings.

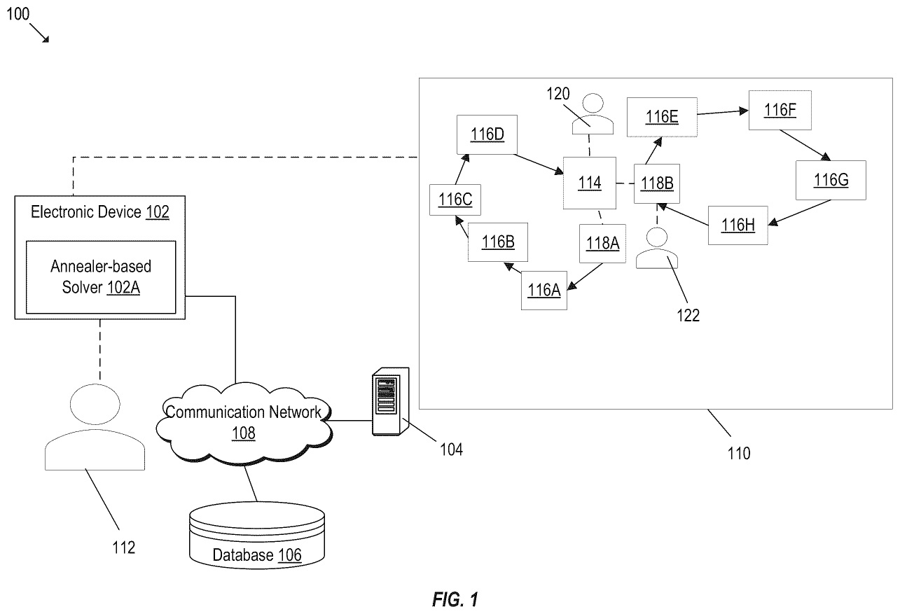

FIG. 1 is a diagram representing an example environment related to random-walk based vehicle routing problem (VRP) partitioning for annealer-based solution, according to at least one embodiment described in the present disclosure. With reference to FIG. 1, there is shown an environment 100. The environment 100 may include an electronic device 102, a server 104, a database 106, a communication network 108, and a vehicle routing environment 110. The electronic device 102, the server 104, and a device hosting the database 106 may be communicatively coupled to one another, via the communication network 108. The electronic device 102 may include an annealer-based solver 102A. In FIG. 1, there is further shown a user 112, who may be associated with or operate the electronic device 102. The vehicle routing environment 110 may include a depot 114, a set of customers 116A to 116H, and a set of vehicles 118A and 118B. An operator 120 may be associated with the depot 114. A driver 122 may be associated with the vehicle 118B. The set of customers 116A to 116H, the set of vehicles 118A and 118B shown in FIG. 1 is presented merely as an example and may include more vehicles or customers, without departure from the scope of the disclosure.

The electronic device 102 may include suitable logic, circuitry, and interfaces that may be configured to solve an optimization problem, such as, the vehicle routing problem (VRP) using the annealer-based solver 102A based on a set of constraints. The electronic device 102 may be further configured to determine a set of optimal routes, between the depot 114 and the set of customers 116A to 116H, for a delivery of a set of items using the set of vehicles 118A and 118B. Examples of the electronic device 102 may include, but are not limited to, a computing device, a hardware-based annealer device, a digital-annealer device, a quantum-based or quantum-inspired annealer device, a smartphone, a cellular phone, a mobile phone, a gaming device, a mainframe machine, a server, a computer workstation, and/or a consumer electronic (CE) device.

The annealer-based solver 102A may be special purpose hardware, for example, quantum or quantum-inspired hardware that may be useful to solve optimization problems. In one or more embodiments of the disclosure, the annealer-based solver 102A may be implemented as a generalized quantum computing device. In such an implementation, the generalized quantum computing device may use specialized optimization solving software applications (e.g., a Quadratic Unconstrained Binary Optimization (QUBO) or using a solver) at an application layer to implement searching algorithms or meta-heuristic algorithms, such as simulated annealing or quantum annealing, to search for a solution to the optimization problem (such as, the VRP) from a discrete solution space.

The generalized quantum computing device may be different from a digital bit-based computing device, such as digital devices that are based on transistor-based digital circuits. The generalized quantum computing device may include one or more quantum gates that use quantum bits (hereinafter referred to as “qubits”) to perform computations for different information processing applications, such as quantum annealing computations for solving combinatorial optimization problems. In general, a qubit can represent “0”, “1”, or a superposition of both “0” and “1”. In most cases, the generalized quantum computing device may need a carefully controlled cryogenic environment to function properly. The generalized quantum computing device uses certain properties found in quantum mechanical systems, such as quantum fluctuations, quantum superposition of its Eigen-states, quantum tunneling, and quantum entanglement. These properties may help the generalized quantum computing device to perform computations for solving certain mathematical problems (e.g., QUBO functions) which are computationally intractable by conventional computing devices. Examples of the generalized quantum computing device may include, but are not limited to, a silicon-based nuclear spin quantum computer, a trapped ion quantum computer, a cavity quantum-electrodynamics (QED) computer, a quantum computer based on nuclear spins, a quantum computer based on electron spins in quantum dots, a superconducting quantum computer that uses superconducting loops and Josephson junctions, and nuclear magnetic resonance quantum computer.

In some other embodiments, the annealer-based solver 102A may be a quantum annealing computer that may be specifically designed and hardware/software optimized to implement searching algorithms or meta-heuristic algorithms, such as simulated annealing or quantum annealing. Similar to the generalized quantum computing device, the quantum annealing computer may also use qubits and may require a carefully controlled cryogenic environment to function properly.

In some other embodiments, the annealer-based solver 102A may correspond to a digital quantum-computing processor for solving user-end combinatorial optimization problems, which may be submitted in the form of a QUBO formulation. More specifically, the annealer-based solver 102A may be a digital annealer that may be based on a semiconductor-based architecture. The digital annealer may be designed to model the functionality of the quantum annealing computer on a digital circuitry. The digital annealer may operate at room temperature and may not require cryogenic environment to function. Also, the digital annealer may have a specific form factor that may allow it to fit on a circuit board that may be small enough to slide into the rack of a computing device or a computing infrastructure, such as a data center.

In some other embodiments, the annealer-based solver 102A may include a processor to execute software instructions associated with one or more searching algorithms and/or meta-heuristic algorithms, such as simulated annealing or quantum annealing. Examples of the implementation of the processor may include, but are not limited to, a Reduced Instruction Set Computing (RISC) processor, an Application-Specific Integrated Circuit (ASIC) processor, a Complex Instruction Set Computing (CISC) processor, a Graphical Processing Unit (GPU), a Co-processor, and/or a combination thereof.

The server 104 may include suitable logic, circuitry, and interfaces, and/or code that may be configured to construct an optimization problem based on the set of constraints. The server 104 may be further configured to construct a random-walk graph based on the constructed optimization problem and the set of constraints. The server 104 may be further configured to apply a graph partitioner on the constructed random-walk graph. The server 104 may be further configured to cluster the set of customers based on the application of the graph partitioner on the constructed random-walk graph. The server 104 may be further configured to split the constructed optimization problem into a set of sub-problems, based on the clustering of the set of customers. The server 104 may be further configured to determine, using an annealer-based solver (e.g., the annealer-based solver 102A), an intermediate solution for each of the set of sub-problems to determine a set of routes associated with the corresponding sub-problem of the set of sub-problems. The server 104 may be further configured to combine the determined intermediate solution associated with each of the set of sub-problems to determine a final solution of the optimization problem based on the received set of constraints, wherein the determined final solution may be indicative of the set of optimal routes to be assigned to the set of vehicles. The server 104 may be further configured to render the determined final solution of the optimization problem on a display device. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that may be well known to those ordinarily skilled in the art. A person with ordinary skill in the art will understand that the scope of the disclosure may not be limited to the implementation of the server 104 and the electronic device 102 as two separate entities. In certain embodiments, the functionalities of the server 104 can be incorporated in its entirety or at least partially in the electronic device 102, without a departure from the scope of the disclosure.

The database 106 may include suitable logic, interfaces, and/or code that may be configured to store information about the set of constraints, information about the set of customers 116A to 116H, and information about the set of vehicles 118A and 118B. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device storing the database 106 may be configured to receive a query for the set of customers 116A to 116H, the set of vehicles 118A and 118B, and/or the set of constraints from the electronic device 102 and/or the server 104. In response, the device of the database 106 may be configured to retrieve and provide the queried the set of constraints, the information about the set of customers 116A to 116H, and/or the information about the set of vehicles 118A and 118B to the electronic device 102 and/or the server 104 based on the received query. In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102, the server 104, the device hosting the database 106, and devices related to the set of customers 116A to 116H and the set of vehicles 118A and 118B may communicate with each other. The communication network 108 may be one of a wired connection or a wireless connection. Examples of the communication network 108 may include, but are not limited to, the Internet, a cloud network, Cellular or Wireless Mobile Network (such as Long-Term Evolution and 5G New Radio), a satellite communication network (such as, a network associated with a set of low-earth orbit satellites), a Wireless Fidelity (Wi-Fi) network, a Personal Area Network (PAN), a Local Area Network (LAN), or a Metropolitan Area Network (MAN). Various devices in the environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

Each of the set of vehicles 118A and 118B may be a non-autonomous vehicle, a semi-autonomous vehicle, or a fully autonomous vehicle, for example, as defined by National Highway Traffic Safety Administration (NHTSA). Examples of the set of vehicles 118A and 118B may include, but are not limited to, a two-wheeler vehicle, a three-wheeler vehicle, a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The set of vehicles 118A and 118B may be a system through which a rider (e.g., the driver 122) may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell based car, a solar powered-car, or a hybrid car. The set of vehicles 118A and 118B may also include heavy road vehicles such as, a truck, a lorry, and the like for transporting goods between the set of customers 116A to 116H and the depot 114. The present disclosure may be also applicable to other types of two-wheelers (e.g., a scooter) or four-wheelers. The description of other types of the vehicle has been omitted from the disclosure for the sake of brevity.

It may be appreciated that the vehicle routing problem (VRP) problem may be the problem of assignment of routes to a set delivery trucks (e.g., the set of vehicles 118A and 118B). Most VRP variants deal with a minimization of the total cost of delivery. Different VRP variants may have different constraints. Common constraints may include, but are not limited to, a certain capacity of trucks, a demand of customers, or a fixed time-window during which deliveries may be made. The electronic device 102 may solve the VRP, as described herein.

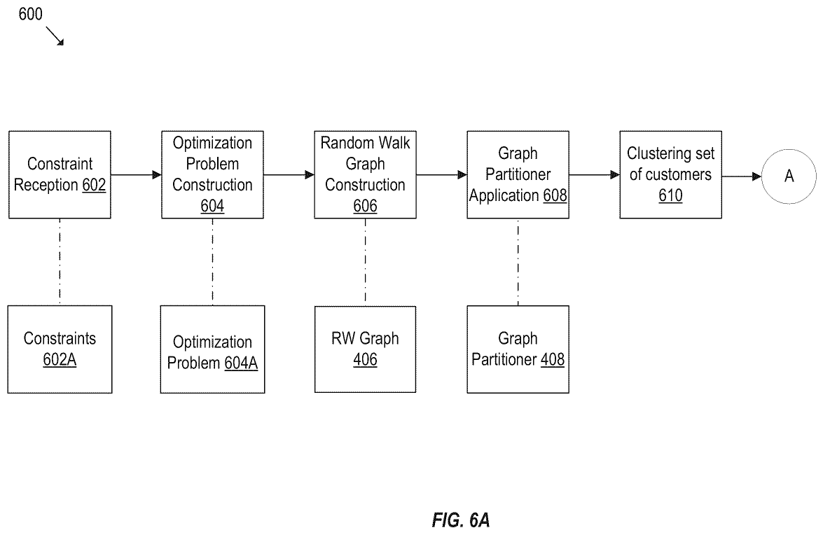

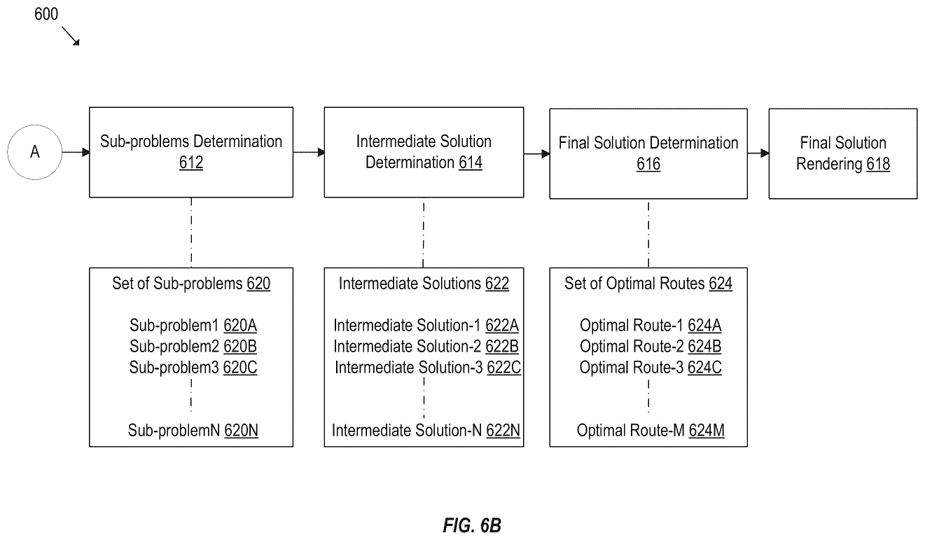

In operation, the electronic device 102 may receive the set of constraints associated with the vehicle routing problem. Herein, the vehicle routing problem may be the optimization problem whose goal may be to determine the set of optimal routes, between the depot 114 and the set of customers 116A to 116H, for the delivery of the set of items using the set of vehicles 118A and 118B. Further, the total cost associated with the set of optimal routes may correspond to the minimum cost associated with the set of possible routes between the depot 114 and the set of customers 116A to 116H. The vehicle routing problem may correspond to the optimization problem for the determination of the set of optimal routes such that the set of vehicles 118A and 118B may transport the set of items between the depot 114 and the set of customers 116A to 116H within a stipulated time at the minimum cost. It may be appreciated that the optimization problem may help to determine best solutions from the set of possible solutions. The best solutions for the vehicle routing problem may be the set of optimal routes. Details of the set of constraints are further provided, for example, in FIG. 6A (at 602).

The electronic device 102 may construct the optimization problem based on the received set of constraints. As discussed, the optimization problem may be a function of the set of constraints, and the goal of the optimization problem may be to determine the set of optimal routes for the vehicle routing problem. A variation in the set of constraints may result in the construction of the new vehicle routing problem. Hence, depending on the received set of constraints, the optimization problem may be constructed. Details related to the construction of the optimization problem are provided, for example, in FIG. 6A (at 604).

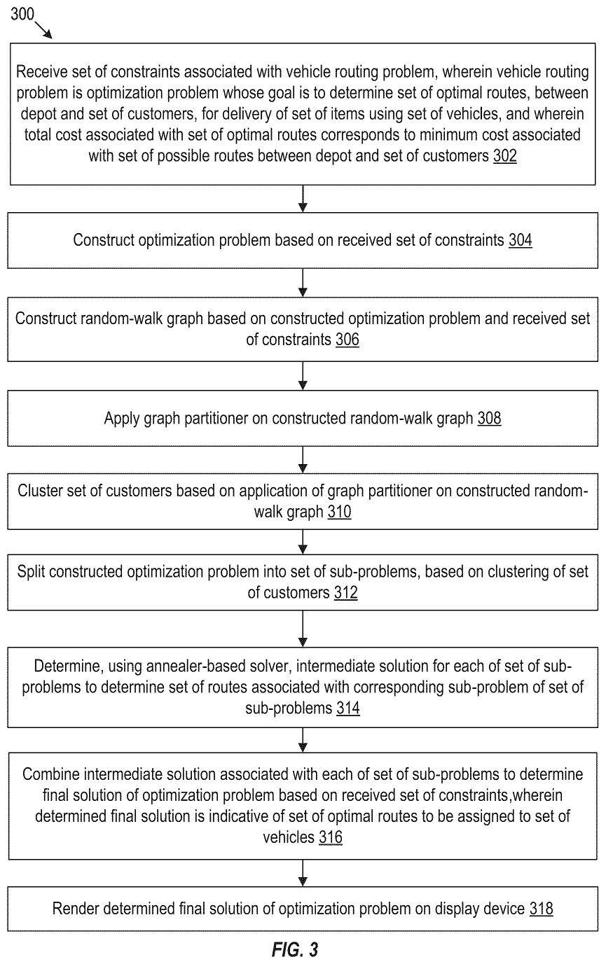

The electronic device 102 may construct the random-walk graph based on the constructed optimization problem and the received set of constraints. The random-walk graph may be constructed by selecting an initial customer as a first vertex and moving to a next vertex after a certain instance. Details related to the construction of the random-walk graph are provided, for example, in FIG. 3 (at 306) and FIG. 6A (at 606).

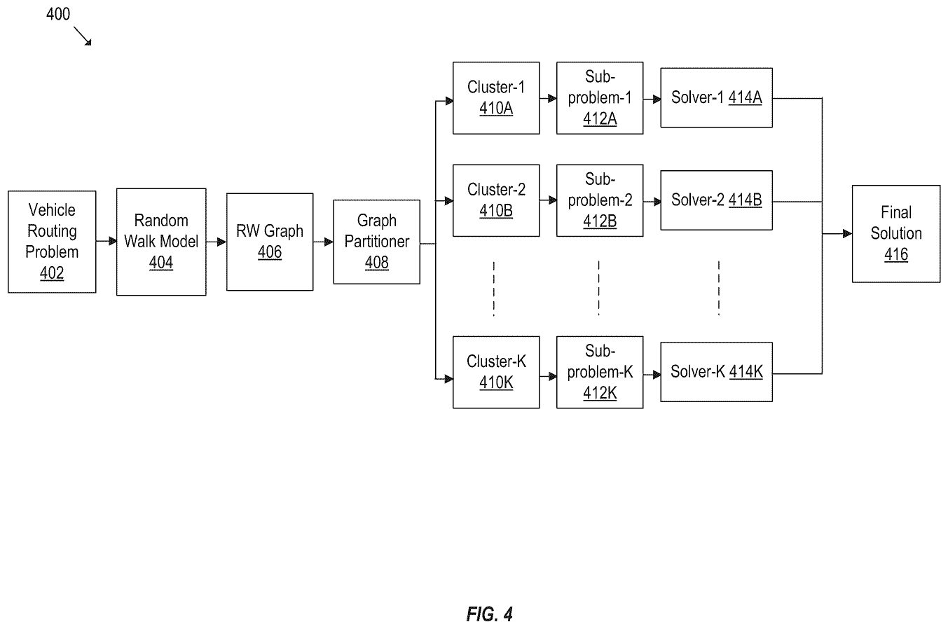

The electronic device 102 may apply the graph partitioner on the constructed random-walk graph. The graph partitioner may divide the constructed random-walk graphs into a set of graphs. Details related to the graph partitioner are provided, for example, in FIG. 4 (at 408) and FIG. 6A (at 608).

The electronic device 102 may cluster the set of customers based on the application of the graph partitioner on the constructed random-walk graph. It may be appreciated that the clustering of the set of customers may allow to reduce the size of the VRP. The set of customers may be clustered into a set of clusters. Herein, each cluster may include a subset of the set of customers. Details related to the clustering of the set of customers are provided, for example, in FIG. 3 (at 310) and FIG. 6A (at 610).

The electronic device 102 may split the constructed optimization problem into the set of sub-problems, based on the clustering of the set of customers. The vehicle routing problem may be quite computationally complex due to a large number of customers and constraints. Hence, complex hardware may be required to solve the VRP optimization problem. Moreover, time taken to solve the complex vehicle routing problem may be longer. Thus, the constructed optimization problem may be split into the set of sub-problems. Details related to the splitting of the constructed optimization problem are described, for example, in FIG. 3 (at 312) and FIG. 6B (at 612).

The electronic device 102 may determine, using the annealer-based solver 102A, the intermediate solution for each of the set of sub-problems to determine the set of routes associated with the corresponding sub-problem of the set of sub-problems. As discussed, the VRP optimization problem may be divided into the set of sub-problems to reduce the complexity. Further, each sub-problem may be solved using the annealer-based solver 102A to determine the intermediate solution for the corresponding sub-problem. The intermediate solution for the corresponding sub-problem may include the set of routes by which the set of vehicles 118A and 118B may transport the set of items to the corresponding subset of customers at a minimum cost. Details related to the intermediate solution are provided, for example, in FIG. 3 (at 314) and FIG. 6B (at 614).

The electronic device 102 may combine the intermediate solution associated with each of the set of sub-problems to determine the final solution of the optimization problem based on the received set of constraints. Herein, the determined final solution may be indicative of the set of optimal routes to be assigned to the set of vehicles 118A and 118B. As the final solution may be obtained by combination of the intermediate solution associated with each of the set of sub-problems, the final solution may be regarded as a complete solution of the VRP optimization problem. Details related to the final solution determination are provided, for example, in FIG. 3 (at 316) and FIG. 6B (at 616).

The electronic device 102 may render the determined final solution of the optimization problem on the display device 208A. The determined final solution may be presented on the display device 208A so that the user 112, and/or the operator 120, and/or the driver 122 associated with the electronic device 102, the depot 114 and the vehicle 118B, respectively, may view the set of optimal routes.

The disclosed electronic device 102 may decompose a large VRP problem into multiple smaller VRP problems. A VRP instance may include an objective value and a number of constraints. The present disclosure provides the random-walk based graph partitioning approach to simplify the design of clustering techniques to sub-divide an optimization problem associated with different VRP variants. The random-walk based graph partitioning approach may cluster the capacitated vehicle routing problem that may allow each cluster to be handled by one vehicle so that total demands for the customers may not exceed vehicle's capacity. The random-walk based graph partitioning approach may cluster the capacitated vehicle routing problem with time-windows, wherein the clustering may be based not only on the geographical distances as nearby customers may have wide time window differences and vehicles may have to wait for the long time if the pair of customer wants to be served consecutively. The random-walk based graph partitioning approach may cluster the capacitated vehicle routing problem with pickup and delivery with time-windows, wherein the customers who have pickup and delivery requests may be put in the same cluster to have their demands satisfied. The present disclosure may find clusters for complex VRP by easily generalizing to VRP variants. Further, in some embodiments, the present disclosure may also consider both distance and angle while clustering the set of customer. The random-walk graph based VRP partitioning and annealer-based solution approach of the disclosure may be simpler and more efficient than typical approaches and may also be easily generalized to various types of VRP variants. Thus, the disclosed random-walk graph based approach may provide optimal solutions for various types of VRP variants, which when implemented for corresponding industrial processes may result in lesser loss in revenue, wastage of time, and requirement of additional man-hours of effort, as compared to traditional approaches.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the database 106. In addition, in some embodiments, the functionality of each of the database 106 and the server 104 may be incorporated into the electronic device 102, without a deviation from the scope of the disclosure.

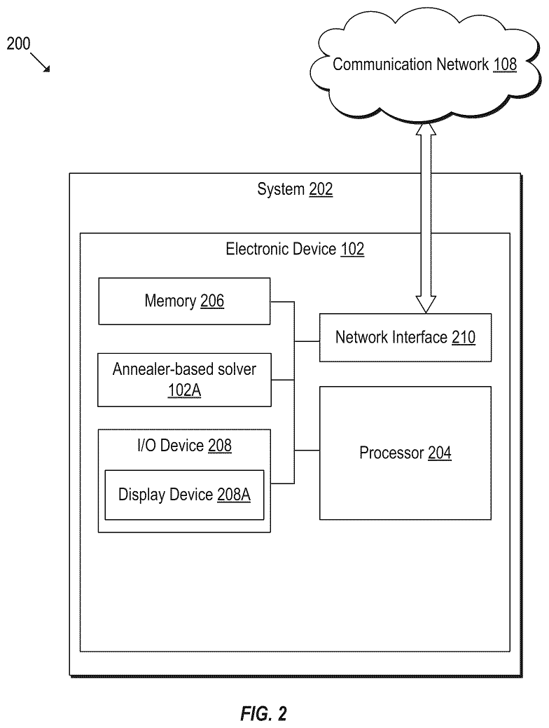

FIG. 2 is a block diagram that illustrates an exemplary electronic device for random-walk based vehicle routing problem (VRP) partitioning for annealer-based solution, in accordance with at least one embodiment described in the present disclosure. FIG. 2 is explained in conjunction with elements from FIG. 1. With reference to FIG. 2, there is shown a block diagram 200 of a system 202 including the electronic device 102. The electronic device 102 may include a processor 204, a memory 206, the annealer-based solver 102A, an input/output (I/O) device 208 (including a display device 208A), and a network interface 210.

The processor 204 may include suitable logic, circuitry, and interfaces that may be configured to execute a set of instructions stored in the memory 206. The processor 204 may be configured to execute program instructions associated with different operations to be executed by the electronic device 102. For example, some of the operations may include reception of the set of constraints. The processor 204 may be configured to construct the optimization problem. The processor 204 may be further configured to construct the random-walk graph based on the constructed optimization problem and the received set of constraints. The processor 204 may be further configured to apply the graph partitioner on the constructed random-walk graph. The processor 204 may be further configured to cluster the set of customers based on the application of the graph partitioner on the constructed random-walk graph. The processor 204 may be further configured to split the constructed optimization problem into the set of sub-problems, based on the clustering of the set of customers. The processor 204 may be further configured to determine, using the annealer-based solver 102A, the intermediate solution for each of the set of sub-problems to determine the set of routes associated with the corresponding sub-problem of the set of sub-problems. The processor 204 may be further configured to combine the determined intermediate solution associated with each of the set of sub-problems to determine the final solution of the optimization problem based on the received set of constraints, wherein the determined final solution may be indicative of the set of optimal routes to be assigned to the set of vehicles.

The processor 204 may be implemented based on a number of processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

Although illustrated as a single processor in FIG. 2, the processor 204 may include any number of processors configured to, individually or collectively, perform or direct performance of any number of operations of the electronic device 102, as described in the present disclosure. Additionally, one or more of the processors may be present on one or more different electronic devices, such as different servers. In some embodiments, the processor 204 may be configured to interpret and/or execute program instructions and/or process data stored in the memory 206. After the program instructions are loaded into the memory 206, the processor 204 may execute the program instructions.

The memory 206 may include suitable logic, circuitry, and interfaces that may be configured to store the one or more instructions to be executed by the processor 204. The one or more instructions stored in the memory 206 may be executed by the processor 204 to perform the different operations of the processor 204 (and the electronic device 102). The memory 206 that may be configured to store the set of constraints, information related to the set of customers 116A to 116H and the set of vehicles 118A and 118B. The memory 206 may be further configured to store information associated with the constructed optimization VRP, the sub-problems, and the partial solutions (i.e., the intermediate solutions) of the set of sub-problems. Examples of implementation of the memory 206 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 208 may include suitable logic, circuitry, and interfaces that may be configured to receive an input from the user 112 and provide an output based on the received input. For example, the I/O device 208 may receive the set of constraints as a user input from the user 112. Further, the I/O device 208 may render the set of optimal routes corresponding to the final solution of the VRP optimization problem as an output for the user 112. The I/O device 208 which may include various input and output devices, may be configured to communicate with the processor 204. Examples of the I/O device 208 may include, but are not limited to, a touch screen, a keyboard, a mouse, a joystick, a microphone, a display device (e.g., the display device 208A), and a speaker.

The display device 208A may include suitable logic, circuitry, and interfaces that may be configured to display the final solution of the VRP optimization problem. The display device 208A may be a touch screen which may enable a user to provide a user-input via the display device 208A. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of a head mounted device (HMD), a smart-glass device, a see-through display, a projection-based display, an electro-chromic display, or a transparent display.

The network interface 210 may include suitable logic, circuitry, and interfaces that may be configured to facilitate communication between the processor 204, the server 104, and a device hosting the database 106 (and/or any other device in the environment 100), via the communication network 108. The network interface 210 may be implemented by use of various known technologies to support wired or wireless communication of the electronic device 102 with the communication network 108. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 210 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

Modifications, additions, or omissions may be made to the example electronic device 102 without departing from the scope of the present disclosure. For example, in some embodiments, the example electronic device 102 may include any number of other components that may not be explicitly illustrated or described for the sake of brevity.

FIG. 3 is a diagram that illustrates a flowchart of an example method for random-walk based vehicle routing problem (VRP) partitioning for annealer-based solution, in accordance with an embodiment of the disclosure. FIG. 3 is described in conjunction with elements from FIG. 1, and FIG. 2. With reference to FIG. 3, there is shown a flowchart 300. The method illustrated in the flowchart 300 may start at 302 and may be performed by any suitable system, apparatus, or device, such as, by the example electronic device 102 of FIG. 1, or the processor 204 of FIG. 2. Although illustrated with discrete blocks, the steps and operations associated with one or more of the blocks of the flowchart 300 may be divided into additional blocks, combined into fewer blocks, or eliminated, depending on the particular implementation.

At block 302, the set of constraints associated with the vehicle routing problem (VRP) may be received. Herein, the vehicle routing problem may be an optimization problem whose goal may be to determine a set of optimal routes, between a depot and a set of customers, for a delivery of a set of items using a set of vehicles. Further, a total cost associated with the set of optimal routes may correspond to a minimum cost associated with a set of possible routes between the depot and the set of customers. In an embodiment, the processor 204 may be configured to receive the set of constraints associated with the vehicle routing problem. In an embodiment, the vehicle routing problem may be the optimization problem whose goal may be to determine the set of optimal routes, between the depot 114 and the set of customers 116A to 116H, for the delivery of the set of items using the set of vehicles 118A and 118B. Further, the total cost associated with the set of optimal routes may correspond to the minimum cost associated with the set of possible routes between the depot 114 and the set of customers 116A to 116H. The vehicle routing problem may correspond to the optimization problem for the determination of the set of optimal routes such that the set of vehicles 118A and 118B may transport the set of items between the depot 114 and the set of customers 116A to 116H within a stipulated time at the minimum cost. It may be appreciated that the optimization problem may help to determine best solutions from the set of possible solutions. The best solutions for the vehicle routing problem may be the set of optimal routes. In an example, the set of optimal routes may be shortest possible routes such that each customer may be visited once, and each vehicle may return to the starting customer (i.e., the depot 114) at the end. In this way, a travel expense and a time required by the set of vehicles 118A and 118B may be saved. The set of constraints may be one or more limitations on which the optimization problem may be bound. For example, in an embodiment, for each route, only one vehicle type and only one action type may be assigned. In an embodiment, the set of constraints may be received as user inputs from the user 112 associated with the electronic device 102. In another embodiment, the set of constraints may be fixed and may be automatically retrieved, for example, from the database 106. The set of optimal routes between the set of customers 116A to 116H and the depot 114 may be determined based on the set of constraints Details of the set of constraints are further provided, for example, in FIG. 6A (at 602).

At block 304, the optimization problem may be constructed based on the received set of constraints. In an embodiment, the processor 204 may be configured to construct the optimization problem based on the received set of constraints. As discussed, the optimization problem may be a function of the set of constraints, and the goal of the optimization problem may be to determine the set of optimal routes for the vehicle routing problem. A variation in the set of constraints may result in the construction of the new vehicle routing problem. Hence, depending on the received set of constraints, the optimization problem may be constructed. Details related to the construction of the optimization problem are provided, for example, in FIG. 6A (at 604).

In an embodiment, the optimization problem may be a quadratic unconstrained binary optimization (QUBO). It may be appreciated that QUBO may be a binary optimization problem, where any term involved in the objective function may be either linear or quadratic and the objective function may be minimized. The objective function for QUBO is provided in an equation (1):

$$Objective function = {\sum }_{( i , j ) ∈ E} {A}_{i j} {x}_{i} {x}_{j} + {\sum }_{i = 1}^{n} {b}_{i} {x}_{i} \qquad ( 1 )$$

where either xᵢ∈{0,1} or xᵢ∈{−1, +1} for all i∈{1, 2, . . . , n}. Several hard combinatorial optimization problems may be modeled by QUBO.

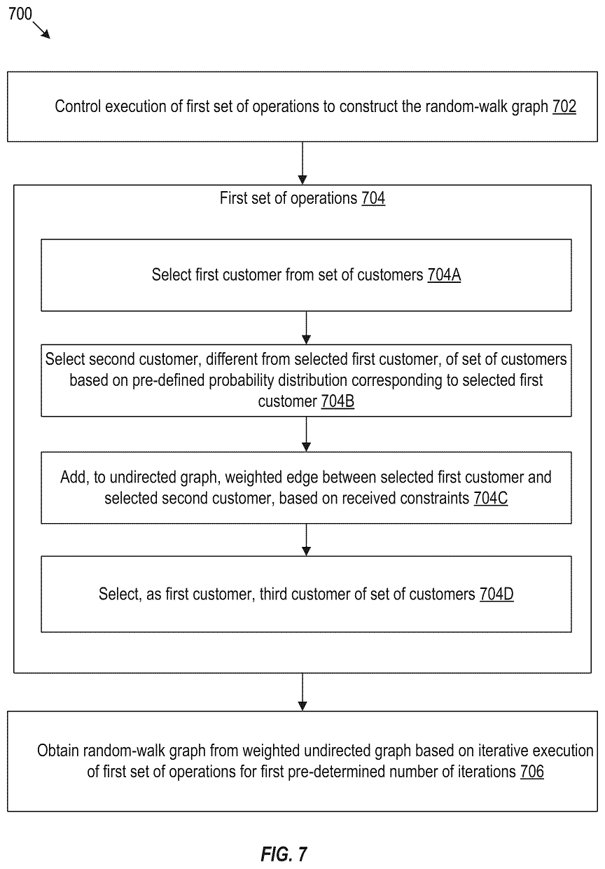

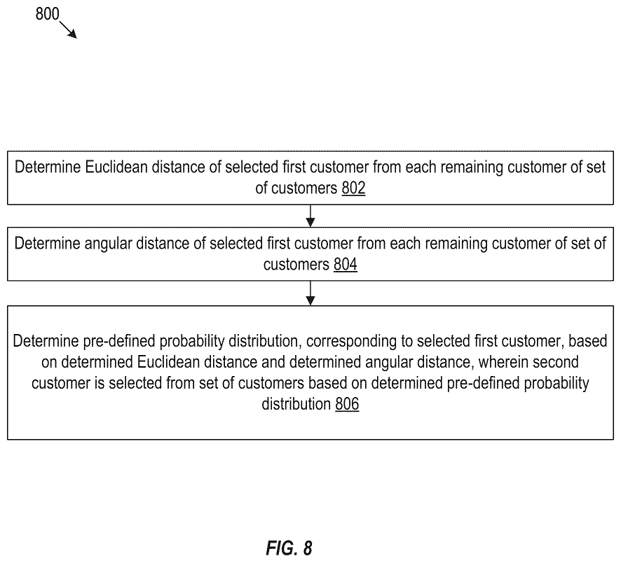

At block 306, the random-walk graph may be constructed based on the constructed optimization problem and the received set of constraints. In an embodiment, the processor 204 may be configured to construct the random-walk graph based on the constructed optimization problem and the received set of constraints. The random-walk graph may be constructed by selecting an initial customer as a first vertex and moving to a next vertex after a certain instance. In an example, the random-walk graph to be constructed may be an unweighted graph and the next vertex may be selected from neighbors of the first vertex randomly. In another example, the random-walk graph to be constructed may be a weighted graph and the next vertex may be selected from neighbors of the first vertex based on a probability that may be function of a weight associated with a corresponding edge. Herein, probabilities of moving to each vertex of the neighbors of the first vertex may be determined and the next vertex may be selected as the one having the highest probability. The process may be repeated till each vertex of a set of vertices associated with the set of customers is covered. Details related to the construction of the random-walk graph are provided, for example, in FIGS. 7 and 8.

At block 308, the graph partitioner may be applied on the constructed random-walk graph. In an embodiment, the processor 204 may be configured to apply the graph partitioner on the constructed random-walk graph. The graph partitioner may divide the constructed random-walk graphs into the set of graphs. Details related to the graph partitioner are provided, for example, in FIG. 4 (at 408). In an example, the VRP may be complex and the set of customers may correspond to ‘n’ number of customers as defined by an equation (2):

$$C = \{ {C}_{1} , … , {C}_{n} \} \qquad ( 2 )$$

where, “C₁” may be a first customer, “C₂” may be a first customer, . . . and “Cₙ” may be a nth customer. The set of customers “C” may be partitioned into “k” disjoint parts or subsets that may correspond to “k” disjoint VRP problems. The “k” disjoint VRP problems may be represented as “VRP₁”, “VRP₂”, . . . “VRPₖ”.

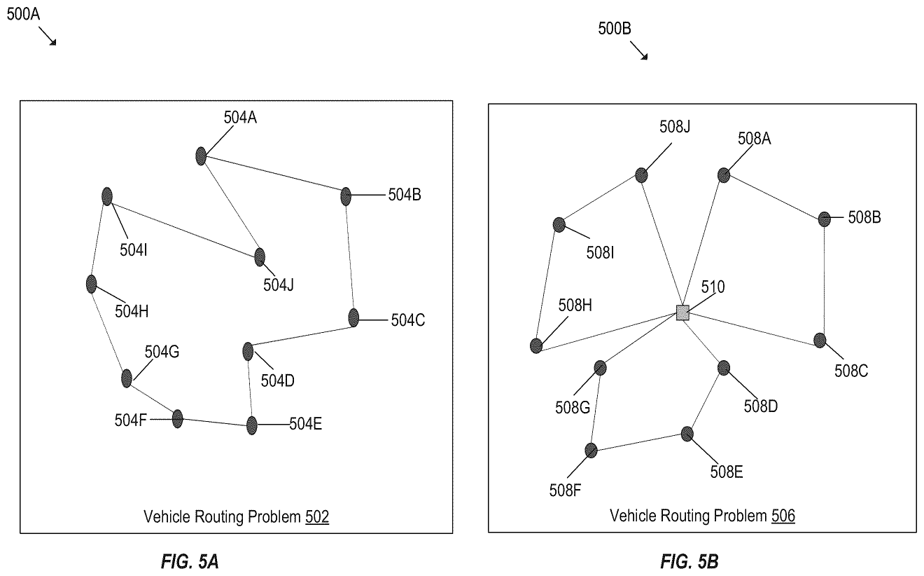

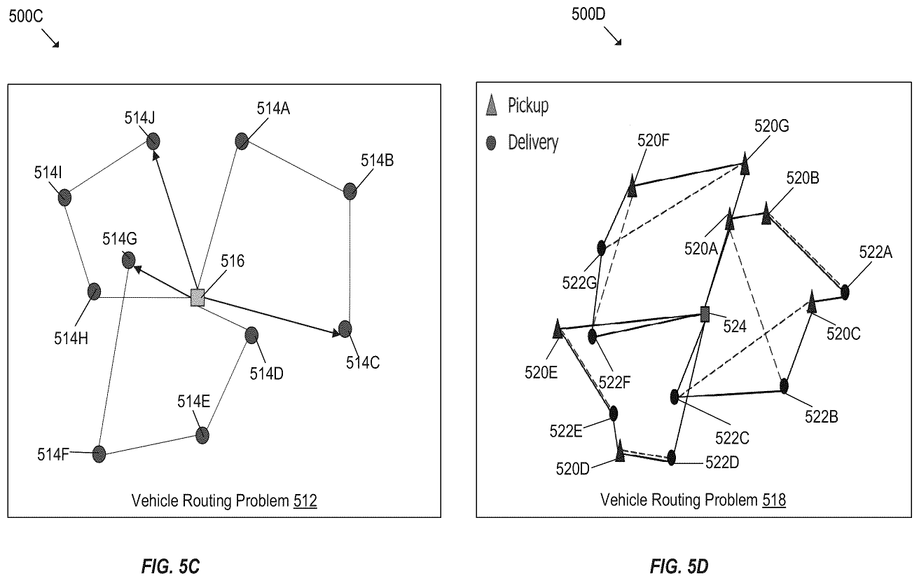

At block 310, the set of customers may be clustered based on the application of the graph partitioner on the constructed random-walk graph. In an embodiment, the processor 204 may be configured to cluster the set of customers based on the application of the graph partitioner on the constructed random-walk graph. It may be appreciated that the clustering of the set of customers may allow to reduce the size of the VRP. The set of customers may be clustered into the set of clusters. Herein, each cluster may include the subset of the set of customers. Typically, nearby customers (i.e., customers within a threshold distance from one another) may be grouped together and taken as one cluster. However, grouping nearby customers based on a heuristic approach that nearby customers are more cost-efficient to be served by one vehicle may lead to sub-optimal solutions. Hence, the present disclosure may cluster the set of customers based on the application of the graph partitioner on the constructed random-walk graph. As discussed, the graph partitioner may divide the constructed random-walk graphs into the set of graphs. A subset of customers of the set of customers involved in a graph of the set of graphs may be grouped together as one cluster. Details related to the clustering of the set of customers are provided, for example, in FIGS. 5A, 5B, 5C, 5D, and 6A.

At block 312, the constructed optimization problem may be split into a set of sub-problems, based on the clustering of the set of customers. In an embodiment, the processor 204 may be configured to split the constructed optimization problem into the set of sub-problems, based on the clustering of the set of customers. As discussed, the vehicle routing problem may be quite computationally complex to solve due to the large number of customers and constraints. Hence, complex hardware may be required to solve the VRP optimization problem. Moreover, due to the complexity of the vehicle routing problem, a large computational time may be required to obtain a solution of the VRP optimization problem that provides a satisfactory result. In order to mitigate aforesaid problems associated with the VRP, the VRP optimization problem may be divided into the set of sub-problems. Herein, each sub-problem may correspond to the subset of customers. For example, if the set of customers comprise “100” customers, then the VRP optimization problem may be divided into “10” sub-problems where each sub-problem may include “10” customers. The division of the VRP optimization problem into the set of sub-problems may help to handle the complexity of the VRP. Complexity of each sub-problem may be lesser than the original VRP optimization problem and hence, solving of each sub-problem of the set of sub-problems may not need complex hardware. Details related to the splitting of the constructed optimization problem in the set of sub-problems are described further, for example, in FIG. 6B (at 612).

At block 314, the intermediate solution for each of the set of sub-problems may be determined using the annealer-based solver 102A to determine the set of routes associated with the corresponding sub-problem of the set of sub-problems. In an embodiment, the processor 204 may be configured to determine, using the annealer-based solver 102A, the intermediate solution for each of the set of sub-problems to determine the set of routes associated with the corresponding sub-problem of the set of sub-problems. As discussed, the VRP optimization problem may be divided into the set of sub-problems to reduce the complexity of the original VRP optimization problem. Further, each sub-problem may be solved using the annealer-based solver 102A to determine the intermediate solution for the corresponding sub-problem. The intermediate solution for the corresponding sub-problem may include the set of routes by which the set of vehicles 118A and 118B may transport the set of items to the corresponding subset of customers at a minimum cost. Each sub-problem of the set of sub-problems may be solved either serially using a single annealer-based solver (e.g., the annealer-based solver 102A) or in parallel using multiple annealer-based solvers (such as, the annealer-based solver 102A). In order to solve each sub-problem serially, the set of sub-problems may be arranged in a queue and may be provided to the annealer-based solver 102A in a serial order. To solve the set of sub-problems in parallel, the set of sub-problems may be fed to the multiple annealer-based solvers at once. Though, solving parallelly may require a greater number of annealer-based solvers, however, a computation time taken to solve the set of sub-problems may be reduced significantly. It may be noted that the intermediate solution associated with each of the set of sub-problems may be a partial solution and not the complete solution of the VRP optimization problem. Details related to the determination of the intermediate solutions of the VRP optimization problem are described, for example, in FIG. 6B (at 614).

At block 316, the intermediate solution associated with each of the set of sub-problems may be combined to determine the final solution of the optimization problem based on the received set of constraints. Herein, the determined final solution may be indicative of a set of optimal routes to be assigned to the set of vehicles. In an embodiment, the processor 204 may be configured to combine the intermediate solution associated with each of the set of sub-problems to determine the final solution of the optimization problem based on the received set of constraints. Herein, the determined final solution may be indicative of the set of optimal routes to be assigned to the set of vehicles 118A and 118B. As the final solution may be obtained by combination of the intermediate solution associated with each of the set of sub-problems, the final solution may be regarded as the complete solution of the VRP optimization problem. The final solution may indicate the set of optimal routes such that the set of vehicles 118A and 118B may transport the set of items to or from the set of customers 116A to 116H and the depot 114 at a minimum cost. Thus, the set of optimal routes may include shortest possible routes that the set of vehicles 118A and 118B may take. For example, if the set of sub-problems include a first sub-problem, a second sub-problem, and a third sub-problem, the intermediate solution of each sub-problem may be combined in order to obtain the final solution. The final solution may be also referred to as an optimal solution that may be determined according to an equation (3):

$$optimal ( VRP ) \approx optimal ( {VRP}_{1} ) + … + optimal ( {VRP}_{k} ) \qquad ( 3 )$$

where, VRP₁ may be first sub-problem, VRPₖ may be a Kth sub-problem. Details related to the final solution determination are described further, for example, in FIG. 6B (at 616).

At block 318, the determined final solution of the optimization problem may be rendered on the display device 208A. In an embodiment, the processor 204 may be configured to render the determined final solution of the optimization problem on the display device 208A. The determined final solution may be presented on the display device 208A so that the user 112, and/or the operator 120, and/or the driver 122 associated with the electronic device 102, the depot 114 and the vehicle 118B, respectively, may view the set of optimal routes. The operator 120 or the user 112 may then instruct the driver 122 of the vehicle 118B to take the set of optimal routes in order to transport the set of items between the depot 114 and the set of customers 116A to 116H. In an embodiment, the final solution may guide the driver 122 to follow the set of optimal routes. Control may pass to end.

Although the flowchart 300 is illustrated as discrete operations, such as 302, 304, 306, 308, 310, 312, 314, 316, and 318. However, in certain embodiments, such discrete operations may be further divided into additional operations, combined into fewer operations, or eliminated, depending on the particular implementation without detracting from the essence of the disclosed embodiments.

FIG. 4 is a diagram that illustrates an exemplary scenario for random-walk based vehicle routing problem (VRP) partitioning for annealer-based solution, in accordance with at least one embodiment described in the present disclosure. FIG. 4 is described in conjunction with elements from FIG. 1, FIG. 2, and FIG. 3. With reference to FIG. 4, there is shown an exemplary scenario 400. The exemplary scenario 400 may include a vehicle routing problem 402, a random walk model 404, a random walk graph 406, a graph partitioner 408, a set of clusters 410A to 410K, a set of sub-problems 412A to 412K, a set of solvers 414A to 414K, and a final solution 416. The K number of clusters, sub-problems, and intermediate solutions are for exemplary purposes and should not be construed to limit the scope of the disclosure. The set of clusters, the set of sub-problems, and the intermediate solutions may include only two or greater than K number of sub-problems, and intermediate solutions, respectively, without departure from the scope of the disclosure.

The processor 204 may be configured to receive the set of constraints associated with the vehicle routing problem 402. Herein, the vehicle routing problem 402 may be the optimization problem, whose goal may be to determine the set of optimal routes, between the depot 114 and the set of customers 116A to 116H, for the delivery of the set of items using the set of vehicles 118A and 118B. Further, the total cost associated with the set of optimal routes may correspond to the minimum cost associated with the set of possible routes between the depot 114 and the set of customers 116A to 116H. In an embodiment, the vehicle routing problem 402 may be a capacitated vehicle routing problem, a vehicle routing problem with time-windows, a pickup and delivery problem with time-windows, or a traveling salesperson problem. The set of possible routes may include all possible routes that the driver 122 may take to deliver the set of items. It may be noted that not all routes of the set of possible routes may be optimal. The travel cost associated with some of the routes may be larger than that associated with other routes. The vehicle routing problem (VRP) 402 may be solved to determine the set of optimal routes from the set of possible routes such that the travel cost associated with the set of vehicles 118A and 118B to transport the set of items to the set of customers 116A to 116H may be the minimum cost. The set of optimal routes between the set of customers 116A to 116H and the depot 114 may be determined based on the set of constraints. The set of constraints may be one or more limitations that may bind the VRP 402. For example, in an embodiment, for each route, only one vehicle type and only one vehicle operation may be assigned. In an embodiment, the set of constraints may be received as user inputs from the user 112 associated with the electronic device 102. In another embodiment, the set of constraints may be fixed and may be automatically retrieved, for example, from the database 106. Details of the set of VRP are further provided, for example, in FIGS. 5A to 5D.

The processor 204 may be configured to construct the optimization problem based on the received set of constraints. As discussed, the optimization problem may be function of the set of constraints, and the goal of the optimization problem may be to determine the set of optimal routes for the vehicle routing problem 402. A variation in the set of constraints may result in a construction of a new vehicle routing problem. Hence, depending on the received set of constraints, the optimization problem may be constructed.

The processor 204 may be configured to construct the random-walk graph 406 based on the constructed optimization problem and the received set of constraints. The random-walk graph 406 may be constructed by providing the VRP 402 to the random walk model 404. The random walk model 404 may be a neural network model that may be trained to construct the random-walk graph 406 based on the VRP 402 provided as an input. The random walk model 404 may construct the random-walk graph 406 by selecting an initial customer as a first vertex and moving to a next vertex after a certain instance. In an example, the random walk model 404 may construct the random-walk graph 406 as an unweighted graph. Herein, the random walk model 404 may select the next vertex from neighbors of the first vertex of the VRP 402 randomly. In another example, the random walk model 404 may construct the random-walk graph 406 as a weighted graph. Herein, the random walk model 404 may select the next vertex from neighbors of the first vertex of the VRP 402 based on the probability that may be proportional to a weight associated with a corresponding edge. The random walk model 404 may repeat the process till each vertex of the set of vertices associated with the set of customers is covered.

The processor 204 may be configured to apply the graph partitioner 408 on the constructed random-walk graph 406. The graph partitioner 408 may divide the constructed random-walk graph 406 into a set of graphs. The constructed random-walk graph 406 may be provided as an input to the graph partitioner 408 for clustering. As discussed, the clustering of the set of customers may allow to reduce the size of the VRP 402. The graph partitioner 408 may cluster the set of customers into the set of clusters 410A to 410K. That is, the graph partitioner 408 may partition the constructed random-walk graph 406 into ‘K’ parts.

The processor 204 may be configured to split the constructed optimization problem into the set of sub-problems 412A to 412K, based on the clustering of the set of customers. Each of the set of sub-problems 412A to 412K may correspond to the subset of customers of the set of customers (e.g., the set of customers 116A to 116H). As discussed, the vehicle routing problem 402 may be quite computationally complex due the large number of customers and the constraints. Hence, the VRP 402 may be divided into the set of sub-problems 412A to 412K. Herein, each sub-problem may correspond to a subset of customers corresponding to a certain cluster of the set of clusters 410A to 410K. With reference to FIG. 4, the VRP 402 may be divided into the set of sub-problems 412A to 412K. Herein, the set of sub-problems 412A to 412K may include K number of sub-problems, such as, a first sub-problem 412A, a second sub-problem 412B, . . . and a Kth sub-problem 412K. In other words, each of the set of sub-problems 412A to 412K may correspond to the subset of the set of clusters 410A to 410K. For example, the first sub-problem 412A may be the sub-problem corresponding to the cluster 410A. Complexity of each sub-problem (such as, the first sub-problem 412A) may be lesser than the complexity of the VRP 402 as a whole and hence, complex hardware may not be required to solve the individual sub-problems. Also, the individual sub-problems may be solved in parallel by multiple solvers, thereby further reducing the computation time required to solve the VRP 402.

The processor 204 may be configured to determine the intermediate solution for each of the set of sub-problems 412A-412K, using an annealer-based solver, such as, the set of solvers 414A-414K, to determine the set of routes associated with the corresponding sub-problem of the set of sub-problems 412A-412K. The intermediate solution for each sub-problem may include the set of routes by which the set of vehicles 118A and 118B may transport the set of items to the subset of customers corresponding to the sub-problem at the minimum cost. Each sub-problem of the set of sub-problems may be solved either serially using a single annealer-based solver (e.g., the annealer-based solver 102A) or in parallel using multiple annealer-based solvers (such as, the annealer-based solver 102A). With reference to FIG. 4, the first sub-problem 412A may be solved using the solver 414A to obtain an intermediate solution-1, the second sub-problems 412B may be solved using the solver 414B to obtain an intermediate solution-2, . . . and the Kth sub-problems 412K may be solved using the solver 414A to obtain an intermediate solution-K.

The processor 204 may combine the intermediate solution associated with each of the set of sub-problems 412A to 412K to determine the final solution 416 of the optimization problem based on the received set of constraints. Herein, the determined final solution 416 may be indicative of the set of optimal routes to be assigned to the set of vehicles (e.g., the set of vehicles 118A and 118B). As the final solution 416 may be obtained based on the combination of the intermediate solution associated with each of the set of sub-problems 412A-412K, the final solution 416 may be regarded as the complete solution of the VRP 402. For example, the intermediate solution-1, the intermediate solution-2, . . . and the intermediate solution-K may be combined to determine the final solution 416.

The processor 204 may be configured to render the determined final solution 416 of the optimization problem on the display device 208A. The determined final solution 416 may be presented on the display device 208A so that the user 112, and/or the operator 120, and/or the driver 122 associated with the electronic device 102, the depot 114 and the vehicle 118B, respectively, may view the set of optimal routes. The operator 120 or the user 112 may then instruct the driver 122 of the vehicle 118B to take the set of optimal routes in order to transport the set of items between the depot 114 and the set of customers 116A to 116H. In an embodiment, the final solution 416 may guide the driver 122 to take the set of optimal routes.

FIG. 5A is a diagram that illustrates a vehicle routing problem corresponding to a traveling salesperson problem, in accordance with at least one embodiment described in the present disclosure. FIG. 5A is described in conjunction with elements from FIG. 1, FIG. 2, FIG. 3, and FIG. 4. With reference to FIG. 5A, there is shown an exemplary scenario 500A. The exemplary scenario 500A may include a vehicle routing problem 502 and a set of cities 504A-504J. The vehicle routing problem 502 may include “J” number of cities. The “J” number of cities is for exemplary purposes and should not be construed to limit the scope of the disclosure. The set of cities may include only two or greater than “J” number of cities, without departure from the scope of the disclosure.

With reference to FIG. 5A, the vehicle routing problem 502 may be a traveling salesperson problem (TSP). In the TSP the objective may be to find a shortest tour through the set of cities 504A-504J such that each city may be visited exactly once, and the salesperson may return to a starting city. For example, if a salesperson starts from a first city 504A, the salesperson may travel to each of the other city of the set of cities 504A-504J and may return to the first city 504A from a Jth city 504J. With reference to FIG. 5A, each of the set of cities 504A-504J may be visited only once.

FIG. 5B is a diagram that illustrates a vehicle routing problem corresponding to a capacitated vehicle routing problem, in accordance with at least one embodiment described in the present disclosure. FIG. 5B is described in conjunction with elements from FIG. 1, FIG. 2, FIG. 3, FIG. 4, and FIG. 5A. With reference to FIG. 5B, there is shown an exemplary scenario 500B. The exemplary scenario 500B may include a vehicle routing problem 506, a set of customers 508A-508J, and a depot 510. The vehicle routing problem 506 includes “J” number of customers. The “J” number of customers is for exemplary purposes and should not be construed to limit the scope of the disclosure. The set of customers may include only two or greater than J number of customers, without departure from the scope of the disclosure.

With reference to FIG. 5B, the vehicle routing problem 506 may be the capacitated vehicle routing problem. In the capacitated vehicle routing problem, the set of vehicles located at a central depot such as, the depot 510, may have to serve a set of geographically dispersed customers. Each vehicle may have a given capacity and each customer may have a given demand. The objective may be to minimize a total distance traveled. With reference to FIG. 5B, a subset of customers 508A-508C may be dispersed around a first geographical region, a subset of customers 508D-508G may be dispersed around a second geographical region, and a subset of customers 508H-508J may be dispersed around a third geographical region. It may be noted that the first geographical region, the second geographical region, and the third geographical region may be the set of clusters. For example, the first geographical region may be a first cluster, the second geographical region may be the second cluster, and the third geographical region may be the third cluster. The set of vehicles may be located at the depot 510. A first subset of vehicles may serve demands of the subset of customers 508A-508C dispersed around the first geographical region. A second subset of vehicles may serve demands of the subset of customers 508D-508G dispersed around the second geographical region. A third subset of vehicles may serve demands of the subset of customers 508H-508J dispersed around the third geographical region.

FIG. 5C is a diagram that illustrates a vehicle routing problem with time-windows, in accordance with at least one embodiment described in the present disclosure. FIG. 5C is described in conjunction with elements from FIG. 1, FIG. 2, FIG. 3, FIG. 4, FIG. 5A, and FIG. 5B. With reference to FIG. 5C, there is shown an exemplary scenario 500C. The exemplary scenario 500C may include a vehicle routing problem 512, a set of customers 514A-514J, and a depot 516. The vehicle routing problem 512 includes “J” number of customers. The “J” number of customers is for exemplary purposes and should not be construed to limit the scope of the disclosure. The set of customers may include only two or greater than “J” number of customers, without departure from the scope of the disclosure.

With reference to FIG. 5C, the vehicle routing problem 512 may be a vehicle routing problem with time-windows. In the vehicle routing problem with time-windows, the set of vehicles may be located at the central depot, such as the depot 516, and may have to serve the set of geographically dispersed customers. Each vehicle may have a given capacity. Each customer may have the given demand and may have to be served within a given time-window. Thus, the vehicle routing problem with time-windows may be similar to the capacitated vehicle routing problem with time-windows. With reference to FIG. 5C, a subset of customers 514A-514C may be dispersed around the first geographical region, a subset of customers 514D-514F may be dispersed around the second geographical region, and a subset of customers 514G-514) may be dispersed around the third geographical region. The set of vehicles may be located at the depot 516. A first subset of vehicles may serve demands of the subset of customers 514A-514C dispersed around the first geographical region. A second subset of vehicles may serve demands of the subset of customers 514D-514G. It may be observed that the customer 514G may lie in the third geographical region. However, the second subset of vehicles may serve the customer 514G because the given time-window associated with the customer 514G may be covered by the second subset of vehicles and not by the third subset of vehicles. A third subset of vehicles may serve demands of the subset of customers 514H-514J dispersed around the third geographical region. Thus, the clustering of the set of customers 514A-514J may be further based the demand and the time-window of each of the set of customers 514A-514J. For example, the subset of customers 514A-514C may be a first cluster, the subset of customers 514D-514G may be a second cluster, the subset of customers 514H-514J may be a third cluster.

FIG. 5D is a diagram that illustrates a vehicle routing problem with pickup and delivery time-windows, in accordance with at least one embodiment described in the present disclosure. FIG. 5D is described in conjunction with elements from FIG. 1, FIG. 2, FIG. 3, FIG. 4, FIG. 5A, FIG. 5B, and FIG. 5C. With reference to FIG. 5D, there is shown an exemplary scenario 500D. The exemplary scenario 500D may include a vehicle routing problem 518, a set of pickup locations 520A-520G, a set of delivery locations 522A-522G, and a depot 524. The vehicle routing problem 518 includes “G” number of pickup and delivery locations. The “G” number of pickup and delivery locations is for exemplary purposes and should not be construed to limit the scope of the disclosure. The set of pickup and the set of delivery locations may include only two or greater than “G” number of pickup and delivery locations, respectively, without departure from the scope of the disclosure.

With reference to FIG. 5D, the vehicle routing problem 512 may be a pickup and delivery problem with time-windows (PDPTW). In the pickup and delivery problem with time-windows, the set of vehicles may be located at the central depot, such as, the depot 524 and may have to serve a number of transportation requests. Each vehicle may have a given capacity. In such case, each of set of customers has at least one of a pickup time window and a delivery time window. Each transportation request may specify a size of the load to be transported, the location where it is to be picked up from along with a pickup time-window, and the location where it is to be delivered along with a delivery time-window. With reference to FIG. 5D, the set of pickup locations 520A-520G may be the locations from where the load may be picked up and the set of delivery locations 522A-522G may be the locations where the load may be delivered up. For example, the load may be picked up from the pickup location 520A within or at the pickup time of the pickup location 520A and may be delivered to a delivery location 522B within or at the delivery time of the delivery location 522B.

It should be noted that the scenarios 500A, 500B, 500C, and 500D of FIG. 5A, FIG. 5B, FIG. 5C, and FIG. 5D, respectively, are for exemplary purposes and should not be construed to limit the scope of the disclosure.

FIGS. 6A and 6B are diagrams that illustrates an execution pipeline for the random-walk based vehicle routing problem (VRP) partitioning for annealer-based solution, in accordance with an embodiment of the disclosure. FIGS. 6A and 6B are described in conjunction with elements from FIG. 1, FIG. 2, FIG. 3, FIG. 4, FIG. 5A, FIG. 5B, FIG. 5C, and FIG. 5D. With reference to FIGS. 6A and 6B, there is shown an execution pipeline 600. The execution pipeline 600 may include a set of constraints 602A, an optimization problem 604A, the RW graph 406, the graph partitioner 408, a set of sub-problems 620, intermediate solutions 622, and a set of optimal routes 624. The exemplary execution pipeline 600 may further include a set of operations that may be executed by one or more components of FIG. 1, such as, the electronic device 102. The operations may include a constraints reception operation 602, an optimization problem construction operation 604, a random-walk construction operation 606, a graph partitioner application operation 608, a clustering set of customers operation 610, a sub-problem determination operation 612, an intermediate solution determination operation 614, and a final solution determination operation 616. The set of operations may be performed by the electronic device 102 to solve the vehicle routing problem (VRP) using annealer-based solvers (such as, the annealer-based solver 102A), as described herein.

At 602, the operation for constraint reception may be executed. In the constraint reception operation, the processor 204 may be configured to receive the set of constraints (for example, received set of constraints 602A) associated with the associated with the vehicle routing problem (for example, the vehicle routing problem 402). The vehicle routing problem may be the optimization problem whose goal may be to determine the set of optimal routes, between the depot 114 and the set of customers 116A to 116H, for the delivery of the set of items using the set of vehicles 118A and 118B. The total cost associated with the set of optimal routes may correspond to the minimum cost associated with the set of possible routes between the depot 114 and the set of customers 116A to 116H. The set of constraints 602A may be one or more limitations that may bind the vehicle routing problem 402. The set of constraints 602A may be received as user inputs from the user 112 associated with the electronic device 102. In another embodiment, the set of constraints may be predefined and may be automatically retrieved, for example, from the database 106.

In an embodiment, the set of constraints 602A may include at least one of, but not limited to, a vehicle type constraint, an action type constraint, a distance validation constraint, a total time constraint, a task and amount matching validation constraint, a route end and stay validation constraint, a disabled route enforcement constraint, a demand constraint, an operation time constraint, a deadline constraint, a maximum load time constraint, a capacity computation constraint, and a vehicle capacity constraint.

The vehicle type constraint may be constraints pertaining to the vehicle type. For example, the vehicle type constraint may define that for each route, exactly one vehicle type and one operation type may be chosen. The action type constraint may define that only one action type may be chosen for each step of each route. The distance validation constraint may state that if a customer “u” is visited at a step “p−1” and a customer “v” is visited at step “p” of the route “r”, then the time taken may correspond to the values in a distance matrix. Herein, the distance matrix may be a table that may include distances between various pairs of customers of the set of customers 116A to 116H, and distances between the depot 114 and any customer of the set of customers 116A to 116H. The total time constraint may be constraints on the total time. The total time constraint may state that the total time may include loading/unloading time. If a vehicle type “u” with operation time “o” is assigned to route “r”, then the total time taken to travel (including loading/unloading time, and waiting time) from step “0” to the next step, say the step “p−1” for route “r”, may be greater than or equal to the sum of the time taken to travel from step “0” to the next step, and the preparation time associated with the vehicle type “u”. The task and amount matching validation constraint may correspond to constraints pertaining to the action type to be performed for a location in the route and the amount of loading or unloading of one or more items at the location in the route. In case the one or more items includes a first item “a” and a second item “b” and if a loading action type “I” is performed on a route “r” at step “p” while visiting the customer “w”, then a sum of an amount of loading of the first item “a” and an amount of loading of the second item “b” at the step “p” on the route “r” while visiting the customer “w” may be greater than zero. Thus, at least one of the first item “a” and/or the second item “b” may be loaded at the step “p”. The route end and stay validation constraint may include a route end constraint, and a stay validation constraint. The route end constraint may state that once a vehicle returns to the depot 114, the vehicle may not visit any other customers afterwards (i.e., the vehicle may return to the depot 114 at the end of each route after visiting customers in the route).

It may be noted that, the number of vehicles of the set of vehicles may not be known. Hence, a large number of vehicles may be assigned in the set of vehicles and some routes may be trivial routes. Some vehicle types may not do anything and may stay at the depot 114. The disabled route enforcement constraint may enforce the above condition. Herein, if a vehicle type say, a vehicle type “0” is chosen for a route such that the vehicle may not visit any customers, then the vehicle may stay at the depot 114 and may be disabled for the route. The demand constraint may ensure that the loading or unloading demands at each customer is met. Therefore, a sum of an amount of the loading or unloading of the first item “a” or the second item “b” at step “p” on a route “r” for the customer “w” may be equal to the demand of the customer “w” for a load/unload action type “α”. The operation time constraint may ensure that a total travel time for each route is less than a chosen operation time for the particular route. The deadline constraint may ensure that each unload action occurs before the corresponding unload deadline. The deadline constraint may further ensure that each load action may occur after the corresponding earliest time to begin loading at the location. The maximum load time constraint may ensure that every step that is chosen as the last loading for a customer may have a load action for the particular customer. The maximum load time constraint may further ensure that final loading occurs after the maximum loading time. The capacity computation constraint may include constraints on computing capacity values. Herein, a total amount of loading or unloading of the first item “a” or the second item b in a route “r” may be greater than or equal to the sum of amount of loading or unloading of the first item “a” or the second item “b” done at each step when visiting each customers on the route “r”. The vehicle capacity constraint may ensure that each vehicle may have the correct loading/unloading capacity.

At 604, an operation for the optimization problem construction may be executed. In the optimization problem construction operation, the processor 204 may be configured to construct the optimization problem 604A based on the received set of constraints 602A. As discussed, the optimization problem 604A may be the function of the received set of constraints 602A, and the goal of the optimization problem 604A may be to determine the set of optimal routes for the vehicle routing problem. A variation in the received set of constraints 602A may result in a construction of a new vehicle routing problem. Hence, depending on the received set of constraints 602A, the optimization problem 604A may be constructed.

At 606, an operation for random-walk graph construction may be executed. In the random-walk graph construction operation, the processor 204 may be configured to construct the random-walk graph 406 based on the constructed optimization problem 604A and the received set of constraints 602A. As discussed, the random-walk graph 406 may be constructed by selecting an initial customer as the first vertex and moving to the next vertex after the certain instance. In an example, the random-walk graph 406 to be constructed may be unweighted and the next vertex may be selected from neighbors of the first vertex randomly. In another example, the random-walk graph to be constructed may be weighted and the next vertex may be selected from neighbors of the first vertex based on a probability that may be function of a weight associated with a corresponding edge. Herein, probabilities of moving to each vertex of the neighbors of the first vertex may be determined and the next vertex may be selected as the one having the highest probability. The process may be repeated till each vertex of a set of vertices associated with the set of customers is covered.

At 608, an operation for the graph partitioner application may be executed. In the graph partitioner application operation, the processor 204 may be configured to apply the graph partitioner 408 on the constructed random-walk (RW) graph 406. The graph partitioner 408 may divide the constructed random-walk graphs 406 into the set of graphs. Details related to the graph partitioner are provided, for example, in FIG. 4.

In an embodiment, the processor 204 may be configured to determine a minimum number of cut-edges associated with the constructed random-walk graph 406, based on a number of nodes associated with the constructed random-walk graph 406. The graph partitioner 408 may be applied on the constructed random-walk graph 406, based on the determined minimum number of cut-edges. The cut-edge may be an edge that may connect a node such as, a customer of one cluster to a node such as, a customer of another cluster. The number of cut-edges associated with the constructed random-walk graph 406 may be taken as minimum in order to reduce connections between cluster that may further reduce the complexity of the set of sub-problems.

At block 610, an operation for the clustering of the set of customers may be executed. In the clustering of the set of customers operation, the processor 204 may be configured to cluster the set of customers 116A to 116H based on the application of the graph partitioner 408 on the constructed random-walk graph 406. It may be noted that finding the optimal solution on mid to large sized VRP may take prohibitively long time with classical algorithms. The entire VRP (such as, the VRP 402) may be solved using quantum-inspired hardware, but converting a CVRP with say, “100” customers and say, “10” vehicles to the quadratic unconstrained binary optimization (QUBO) problem may take say, “100,000” binary variables. Hence, the set of customers associated with the constructed random-walk graph 406 may be clustered. It may be appreciated that the clustering of the set of customers 116A to 116H may allow to reduce the size of the VRP 402. The set of customers 116A to 116H may be clustered into the set of clusters. Herein, each cluster may include the subset of the set of customers. As discussed, the graph partitioner may divide the constructed random-walk graph 406 into the set of graphs. A subset of customers of the set of customers involved in the graph of the set of graphs may be grouped together as one cluster.

In an embodiment, the vehicle routing problem 402 may be the capacitated vehicle routing problem, and each cluster of the clustered set of customers may be handled by one vehicle of the set of vehicles 118A and 118B such that a demand of a subset of customers in the corresponding cluster does not exceed a capacity of the vehicle. As discussed, in the capacitated vehicle routing problem, the set of vehicles located at a central depot such as, the depot 510 may have to serve a set of geographically dispersed customers. Each vehicle may have the given capacity and each customer may have the given demand. The objective may be to minimize the total distance traveled. Hence, clustering of the capacitated vehicle routing problem may be done in such a way that each cluster of the clustered set of customers may be handled by one vehicle of the set of vehicles 118A and 118B such that the demand of the subset of customers may be met. Details of the capacitated vehicle routing problem have been provided, for example, in FIG. 5B.

In an embodiment, the vehicle routing problem 402 may be the vehicle routing problem with time-windows. Each of the set of customers 116A to 116H may have a demand that needs to be served in a time-window, and the clustering of the set of customers 116A to 116H may be further based on the demand and the time-window of each of the set of customers 116A to 116H. In the vehicle routing problem with time-windows, the set of vehicles may be located at the central depot, such as the depot 516 and may have to serve the set of geographically dispersed customers. Each vehicle may have the given capacity. Each customer may have the given demand and may have to be served within the given time-window. That is, the vehicle routing problem with time-windows may be similar to the capacitated vehicle routing problem with time-windows. Thus, in the vehicle routing problem with time-windows, the set of customers 116A to 116H may be clustered further based the demand and the time-window of each of the set of customers 116A to 116H. Details of the vehicle routing problem with time-windows have been provided, for example, in FIG. 5C.

In an embodiment, the vehicle routing problem 402 may be a pickup and delivery problem with time-windows. Each of set of customers may have at least one of a pickup time-window and a delivery time-window, and clustering of the set of customers may be further based on the pickup time-window and the delivery time-window. As discussed, in the pickup and delivery problem with time-windows, the set of vehicles may be located at the central depot, such as the depot 524 and may have to serve a number of transportation requests. Each vehicle may have the given capacity. Each transportation request may specify the size of the load to be transported, the location where it is to be picked up from along with the pickup time-window, and the location where it is to be delivered along with the delivery time-window. The set of customers may be clustered based on the pickup time-window and the delivery time-window. Details of the pickup and delivery problem with time-windows have been provided, for example, in FIG. 5D.

At 612, an operation for the sub-problem determination may be executed. In sub-problem determination operation, the processor 204 may be configured to divide the constructed optimization problem 604A into the set of sub-problems 620. Each of the set of sub-problems 620 may correspond to the subset of customers of the set of customers 116A to 116H. As discussed, the vehicle routing problem 402 may be computationally complex due to the large number of customers, constraints, decision variables, and parameters. Hence, complex hardware may be required to solve the optimization problem 604A. Moreover, due to the complexity of the vehicle routing problem 402, a computation time to obtain satisfactory solution of the VRP 402 may be significant. In order to mitigate aforesaid problems associated with the VRP 402, the VRP 402 may be divided into the set of sub-problems 620. Herein, each of the set of sub-problems 620 may correspond to the subset of customers. With reference to FIG. 6B, the optimization problem 604A may be divided into the set of sub-problems 620. Herein, the set of sub-problems 620 may include N number of sub-problems such as, a sub-problem-1 620A, a sub-problem-2 620B, . . . and a sub-problem-N 620N. Complexity of each sub-problem (such as, the sub-problem-1) may be lesser than the complexity of the overall optimization problem 604A. Hence, the individual sub-problems of the set of sub-problems 620 may be solved using relatively inexpensive solvers (such as, digital annealer-based solvers).

At 614, an operation for the intermediate solution determination may be executed. In the intermediate solution determination operation, the processor 204 may be configured to determine the intermediate solution for each of the set of sub-problems 620, using the annealer-based solver 102A, to determine the set of routes associated with the corresponding sub-problem of the set of sub-problems 620. As discussed, the VRP 402 problem may be divided into the set of sub-problems 620 to reduce the complexity. Further, each sub-problem may be solved using the annealer-based solver 102A to determine the intermediate solution for the corresponding sub-problem. Herein, each sub-problem may be associated with certain subset of customers from the set of customers 116A to 116H. The intermediate solution for each sub-problem may include the set of routes by which the set of vehicles 118A and 118B may transport the set of items to the corresponding subset of customers at a minimum cost. Each intermediate solution may be a partial solution of the optimization problem 604A and may include such set of routes associated with the corresponding subset of customers. For example, the sub-problem-1 620A may be solved to obtain an intermediate solution-1 622A, the sub-problem-2 620B may be solved to obtain an intermediate solution-2 622B, . . . and the sub-problem-N 620N may be solved to obtain an intermediate solution-N 622N. Each sub-problem of the set of sub-problems 620 may be solved either serially using a single annealer-based solver (such as, the annealer-based solver 102A) or in parallel using multiple annealer-based solvers (such as, the annealer-based solver 102A). In order to solve each sub-problem serially, the set of sub-problems 620 may be arranged in the queue and may be provided to the annealer-based solver 102A in a serial order. For example, the annealer-based solver 102A may first solve the sub-problem-1 620A to obtain the intermediate solution-1 622A. Further, the annealer-based solver 102A may solve the sub-problem-2 620B to obtain the intermediate solution-2 622B and so on, till the sub-problem-N 620N is solved. To solve the set of sub-problems 620 in parallel, the set of sub-problems 620 may be fed to the multiple annealer-based solvers at once. For example, “N” number of annealer-based solvers may be employed. A first annealer-based solver may solve the sub-problem-1 620A, a second annealer-based solver may solve the sub-problem-2 620B, and so on. Solution of the set of sub-problems 620 in parallel may require a multiple annealer-based solvers but the time taken to solve the set of sub-problems 620 may be reduced.

At 616, an operation for the final solution determination may be executed. In the final solution determination operation, the processor 204 may be configured to combine the intermediate solution associated with each of the set of sub-problems 620 to determine the final solution of the optimization problem 604A based on the received set of constraints 602A. Herein, the determined final solution may be indicative of a set of optimal routes 624 to be assigned to the set of vehicles. As the final solution may be obtained based on a combination of the intermediate solutions 622 associated with each of the set of sub-problems 620, the final solution may be regarded as a complete solution of the VRP optimization problem. Such complete solution may correspond to the entire set of customers (e.g., the set of customers 116A to 116H). The final solution may indicate the set of optimal routes 624 such that the set of vehicles 118A and 118B may transport the set of items between the set of customers 116A to 116H and the depot 114 at a minimum cost. Thus, the set of optimal routes 624 may include shortest possible routes that the set of vehicles 118A and 118B may take. With reference to FIG. 5B, the intermediate solution-1 622A, the intermediate solution-2 622B, . . . and the intermediate solution-N 622N may be combined to determine the final solution. The set of optimal routes 624 may include optimal routes such as, an optimal route-1 624A, an optimal route-2 624B, . . . and an optimal route-M 624M.

At 618, an operation for the final solution rendering may be executed. In the final solution rendering operation, the processor 204 may be configured to render the determined final solution of the optimization problem on a display device (such as a display device 208A of FIG. 2). The determined final solution may be presented on the display device so that the user 112, and/or the operator 120, and/or the driver 122 associated with the electronic device 102, the depot 114 and the vehicle 118B, respectively, may view the set of optimal routes. The operator 120 or the user 112 may then instruct the driver 122 of the vehicle 118B to take the set of optimal routes in order to transport the set of items between the depot 114 and the set of customers 116A to 116H. In an embodiment, the final solution may guide the driver 122 to take the set of optimal routes. For example, the display device may provide a guidance such as, a map to guide the driver 122 to follow the set of optimal routes.

FIG. 7 is a diagram that illustrates flowchart of an example method for obtaining a random-walk graph, in accordance with at least one embodiment described in the present disclosure. FIG. 7 is described in conjunction with elements from FIG. 1, FIG. 2, FIG. 3, FIG. 4, FIG. 5A, FIG. 5B, FIG. 5C, FIG. 5D, FIG. 6A, and FIG. 6B. With reference to FIG. 7, there is shown a flowchart 700. The method illustrated in the flowchart 700 may start at 702 and may be performed by any suitable system, apparatus, or device, such as by the example electronic device 102 of FIG. 1 or the processor 204 of FIG. 2. Although illustrated with discrete blocks, the steps and operations associated with one or more of the blocks of the flowchart 700 may be divided into additional blocks, combined into fewer blocks, or eliminated, depending on the particular implementation.

At block 702, a first set of operations 704 may be executed to construct the random-walk graph. The processor 204 may be configured to control the execution of the first set of operations 704 to construct the random-walk graph. The first set of operations 704 may include blocks 704A to 704D that are described in the succeeding paragraphs.

At block 704A, a first customer may be selected from the set of customers. The processor 204 may be configured to select the first customer from the set of customers. The first customer may be a starting customer that may be selected uniformly at random. For example, the random walk model 404 or the processor 204 may select customer 116B as the first customer.

At block 704B, a second customer, different from the selected first customer of the set of customers, may be selected based on a pre-defined probability distribution corresponding to the selected first customer. The processor 204 may be configured to select the second customer, different from the selected first customer of the set of customers, based on the pre-defined probability distribution corresponding to the selected first customer. The second customer may be the next customer that a given vehicle may visit after visiting the first customer. The second customer may be selected based on the pre-defined probability distribution corresponding to the selected first customer.

In an embodiment, the pre-defined probability distribution may be at least one of a distance-based probability distribution or an angle-based probability distribution. As discussed, the random-walk may select the next customer based on the pre-defined probability distribution. In the distance-based probability distribution, a customer that may be nearest to the first customer may have a highest probability and the random-walk may select the customer that is nearest to the first customer as the second customer. In the angle-based probability distribution customer with a smallest angle with the first customer may have the highest probability and the random-walk may select the customer that is within the smallest angle with the first customer as the second customer.

At block 704C, a weighted edge between the selected first customer and the selected second customer may be added to an undirected graph, based on the received constraints. The processor 204 may be configured to add, to the undirected graph, the weighted edge between the selected first customer and the selected second customer, based on the received constraints. After performing, say “K” walks, a number of times each pair of customers is visited consecutively may be counted. The weighted edge between the selected first customer and the selected second customer maybe added based on the count. It may be noted that, the random-walk may be performed based on the received set of constraints. For example, if there are time windows then the random-walk may consider the time windows.

At block 704D, a third customer of the set of customers may be selected as the first customer. The processor 204 may be configured to select, as the first customer, the third customer of the set of customers. The third customer may be now selected as the first customer and the step 704C may be repeated. Herein, the third customer may be a customer selected (at the step 704C) uniformly at random from the set of customers. The third customer may be different from the second customer.

At block 706, the random-walk graph may be obtained from the weighted undirected graph based on an iterative execution of the first set of operations for a first pre-determined number of iterations. The processor 204 may be configured to obtain the random-walk graph from the weighted undirected graph based on the iterative execution of the first set of operations for the first pre-determined number of iterations. The obtained random-walk graph may be a weighted undirected graph, where customers having heavy edges may be clustered into a same cluster. Control may pass to end.

Although the flowchart 700 is illustrated as discrete operations, such as 702, 704 (including, for example, 704A, 704B, 704C, and 704D), and 706. However, in certain embodiments, such discrete operations may be further divided into additional operations, combined into fewer operations, or eliminated, depending on the particular implementation without detracting from the essence of the disclosed embodiments.

FIG. 8 is a diagram that illustrates a flowchart of an example method for a determination of a pre-defined probability distribution, in accordance with at least one embodiment described in the present disclosure. FIG. 8 is described in conjunction with elements from FIG. 1, FIG. 2, FIG. 3, FIG. 4, FIG. 5A, FIG. 5B, FIG. 5C, FIG. 5D, FIG. 6A, FIG. 6B, and FIG. 7. With reference to FIG. 8 there is shown a flowchart 800. The method illustrated in the flowchart 800 may start at 802 and may be performed by any suitable system, apparatus, or device, such as by the example electronic device 102 of FIG. 1 or the processor 204 of FIG. 2. Although illustrated with discrete blocks, the steps and operations associated with one or more of the blocks of the flowchart 800 may be divided into additional blocks, combined into fewer blocks, or eliminated, depending on the particular implementation.

At block 802, a Euclidean distance of the selected first customer from each remaining customer of the set of customers may be determined. In an embodiment, the processor 204 may be configured to determine the Euclidean distance of the selected first customer from each remaining customer of the set of customers. It may be appreciated that the Euclidean distance may be the length of a line segment between a first point and a second point. The first point may correspond to the selected first customer and the second point may correspond to each remaining customer of the set of customers.

At block 804, an angular distance of the selected first customer may be determined from each remaining customer of the set of customers. In an embodiment, the processor 204 may be configured to determine the angular distance of the selected first customer from each remaining customer of the set of customers. The angular distance may be an angle with at which each remaining customer of the set of customers may be from the first customer.

At block 806, the pre-defined probability distribution, corresponding to the selected first customer, may be determined based on the determined Euclidean distance and the determined angular distance. The second customer may be selected from the set of customers based on the determined pre-defined probability distribution. In an embodiment, the processor 204 may be configured to determining the pre-defined probability distribution, corresponding to the selected first customer, based on the determined Euclidean distance and the determined angular distance, wherein the second customer may be selected from the set of customers based on the determined pre-defined probability distribution. For each edge, a measure “c_{i,j}” may be defined according to an equation (4) as follows:

$${c}_{i , j} = {θ}_{i , j} + α \cdot {d}_{i , j} \qquad ( 4 )$$

where “θᵢⱼ” may be a polar angle difference between the customers and “dᵢⱼ” may be a Euclidean distance. The probability of visiting a customer “j” after “i” may be according to an equation (5) as follows:

$$prob ( i , j ) ∝ \frac{1}{{e}^{{c}_{i , j} + b}} \qquad ( 5 )$$

where, “prob(i,j)” may be the probability of visiting a customer “j” after “i”, “c_{i,j}” may be the measure determined according to the equation (4). Control may pass to end.

Although the flowchart 800 is illustrated as discrete operations, such as 802, 804, and 806. However, in certain embodiments, such discrete operations may be further divided into additional operations, combined into fewer operations, or eliminated, depending on the particular implementation without detracting from the essence of the disclosed embodiments.

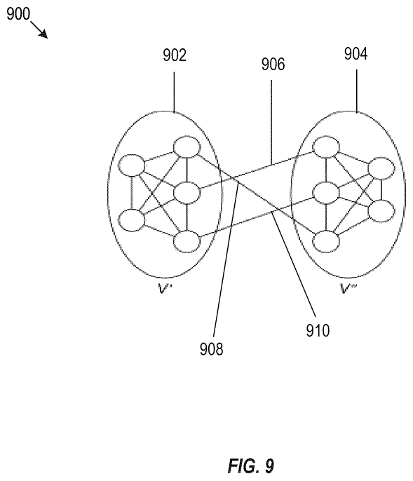

FIG. 9 is a diagram that illustrate an exemplary scenario of a random walk graph, in accordance with at least one embodiment described in the present disclosure. FIG. 9 is described in conjunction with elements from FIG. 1, FIG. 2, FIG. 3, FIG. 4, FIG. 5A, FIG. 5B, FIG. 5C, FIG. 5D, FIG. 6A, FIG. 6B, FIG. 7, and FIG. 8. With reference to FIG. 9, there is shown an exemplary scenario 900. The scenario 900 may include a first cluster of customers 902, a second cluster of customers 904, a first cut-edge 906, a second cut-edge 908, and a third cut-edge 910.

With reference to FIG. 9, the set of customers, such as, the set of customers 116A to 116H may be clustered into the first cluster of customers 902 and the second cluster of customers 904. The first cut-edge 906, the second cut-edge 908, and the third cut-edge 910 may be the edges that may connect the first cluster of customers 902 and the second cluster of customers 904. The goal may be to have a minimum number of cut-edges to reduce the complexity of each of the set of sub-problems.

It should be noted that the scenario 900 of FIG. 9 is for exemplary purposes and should not be construed to limit the scope of the disclosure.

The disclosed electronic device 102 may decompose the large VRP problem into multiple smaller VRP problems. The present disclosure may provide the random-walk based graph partitioning approach to simplify the design of clustering techniques on different VRP variants. The random-walk based graph partitioning approach may cluster the capacitated vehicle routing problem that may allow each cluster to be handled by one vehicle so that total demands for the customers may not exceed vehicle's capacity. The random-walk based graph partitioning approach may cluster the capacitated vehicle routing problem with time-windows. The clustering may be based not only on the geographical distances as nearby customers may have wide time window differences and vehicles may have to wait for the long time if the pair of customer wants to be served consecutively. The random-walk based graph partitioning approach may cluster the capacitated vehicle routing problem with pickup and delivery with time-windows. The customers who have pickup and delivery requests may be put in the same cluster to have their demands satisfied. The present disclosure may find clusters for complex VRP by easily generalizing to VRP variants. Further, in some embodiments, the present disclosure may also consider both distance and angle while clustering the set of customers.

Various embodiments of the disclosure may provide one or more non-transitory computer-readable storage media configured to store instructions that, in response to being executed, cause a system (such as, the example electronic device 102) to perform operations. The operations may include receiving a set of constraints associated with a vehicle routing problem. The vehicle routing problem may be an optimization problem whose goal is to determine a set of optimal routes, between a depot and a set of customers, for a delivery of a set of items using a set of vehicles. A total cost associated with the set of optimal routes may correspond to a minimum cost associated with a set of possible routes between the depot and the set of customers. The operations may include constructing the optimization problem based on the received set of constraints. The operations may include constructing a random-walk graph based on the constructed optimization problem and the received set of constraints. The operations may include applying a graph partitioner on the constructed random-walk graph. The operations may include clustering the set of customers based on the application of the graph partitioner on the constructed random-walk graph. The operations may include splitting the constructed optimization problem into a set of sub-problems, based on the clustering of the set of customers. The operations may include determining, using an annealer-based solver, an intermediate solution for each of the set of sub-problems to determine a set of routes associated with the corresponding sub-problem of the set of sub-problems. The operations may include combining the determined intermediate solution associated with each of the set of sub-problems to determine a final solution of the optimization problem based on the received set of constraints, wherein the determined final solution may be indicative of the set of optimal routes to be assigned to the set of vehicles. The operations may include rendering the determined final solution of the optimization problem on a display device.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor, comprising:
receiving a set of constraints associated with a vehicle routing problem, wherein
the vehicle routing problem is an optimization problem whose goal is to determine a set of optimal routes, between a depot and a set of customers, for a delivery of a set of items using a set of vehicles, and
a total cost associated with the set of optimal routes corresponds to a minimum cost associated with a set of possible routes between the depot and the set of customers;
constructing the optimization problem based on the received set of constraints;
constructing a random-walk graph based on the constructed optimization problem and the received set of constraints;
applying a graph partitioner on the constructed random-walk graph;
clustering the set of customers based on the application of the graph partitioner on the constructed random-walk graph;
splitting the constructed optimization problem into a set of sub-problems, based on the clustering of the set of customers;
determining, using an annealer-based solver, an intermediate solution for each of the set of sub-problems to determine a set of routes associated with the corresponding sub-problem of the set of sub-problems;
combining the determined intermediate solution associated with each of the set of sub-problems to determine a final solution of the optimization problem based on the received set of constraints, wherein
the determined final solution is indicative of the set of optimal routes to be assigned to the set of vehicles; and
rendering the determined final solution of the optimization problem on a display device.

2. The method according to claim 1, wherein the received set of constraints comprises at least one of a vehicle type constraint, an action type constraint, a distance validation constraint, a total time constraint, a task and amount matching validation constraint, a route end and stay validation constraint, a disabled route enforcement constraint, a demand constraint, an operation time constraint, a deadline constraint, a maximum load time constraint, a capacity computation constraint, and a vehicle capacity constraint.

3. The method according to claim 1, wherein
the vehicle routing problem is a capacitated vehicle routing problem, and
each cluster of the clustered set of customers is handled by one vehicle of the set of vehicles such that a demand of a subset of customers in the corresponding cluster does not exceed a capacity of the vehicle.

4. The method according to claim 1, wherein
the vehicle routing problem is a vehicle routing problem with time-windows,
each of the set of customers has a demand that needs to be served in a time window, and
the clustering of the set of customers is further based the demand and the time window of each of the set of customers.

5. The method according to claim 1, wherein
the vehicle routing problem is a pickup and delivery problem with time-windows,
each of set of customers has at least one of a pickup time window and a delivery time window, and
clustering of the set of customers is further based the pickup time window and the delivery time window.

6. The method according to claim 1, further comprising:
controlling an execution of a first set of operations to construct the random-walk graph, wherein the first set of operations includes:
selecting a first customer from the set of customers,
selecting a second customer, different from the selected first customer, of the set of customers based on a pre-defined probability distribution corresponding to the selected first customer,
adding, to an undirected graph, a weighted edge between the selected first customer and the selected second customer, based on the received constraints, and
selecting, as the first customer, a third customer of the set of customers; and
obtaining the random-walk graph from the weighted undirected graph based on an iterative execution of the first set of operations for a first pre-determined number of iterations.

7. The method according to claim 6, wherein the pre-defined probability distribution is at least one of a distance-based probability distribution or an angle-based probability distribution.

8. The method according to claim 6, further comprising:
determining a Euclidean distance of the selected first customer from each remaining customer of the set of customers;
determining an angular distance of the selected first customer from each remaining customer of the set of customers; and
determining the pre-defined probability distribution, corresponding to the selected first customer, based on the determined Euclidean distance and the determined angular distance, wherein
the second customer is selected from the set of customers based on the determined pre-defined probability distribution.

9. The method according to claim 1, further comprising
determining a minimum number of cut-edges associated with the constructed random-walk graph, based on a number of nodes associated with the constructed random-walk graph, wherein
the graph partitioner is applied on the constructed random-walk graph based on the determined minimum number of cut-edges.

10. One or more non-transitory computer-readable storage media configured to store instructions that, in response to being executed, cause an electronic device to perform operations, the operations comprising:
receiving a set of constraints associated with a vehicle routing problem, wherein
the vehicle routing problem is an optimization problem whose goal is to determine a set of optimal routes, between a depot and a set of customers, for a delivery of a set of items using a set of vehicles, and
a total cost associated with the set of optimal routes corresponds to a minimum cost associated with a set of possible routes between the depot and the set of customers;
constructing the optimization problem based on the received set of constraints;
constructing a random-walk graph based on the constructed optimization problem and the received set of constraints;
applying a graph partitioner on the constructed random-walk graph;
clustering the set of customers based on the application of the graph partitioner on the constructed random-walk graph;
splitting the constructed optimization problem into a set of sub-problems, based on the clustering of the set of customers;
determining, using an annealer-based solver, an intermediate solution for each of the set of sub-problems to determine a set of routes associated with the corresponding sub-problem of the set of sub-problems;
combining the determined intermediate solution associated with each of the set of sub-problems to determine a final solution of the optimization problem based on the received set of constraints, wherein
the determined final solution is indicative of the set of optimal routes to be assigned to the set of vehicles; and
rendering the determined final solution of the optimization problem on a display device.

11. The one or more non-transitory computer-readable storage media according to claim 10, wherein the received set of constraints comprises at least one of a vehicle type constraint, an action type constraint, a distance validation constraint, a total time constraint, a task and amount matching validation constraint, a route end and stay validation constraint, a disabled route enforcement constraint, a demand constraint, an operation time constraint, a deadline constraint, a maximum load time constraint, a capacity computation constraint, and a vehicle capacity constraint.

12. The one or more non-transitory computer-readable storage media according to claim 10, wherein
the vehicle routing problem is a capacitated vehicle routing problem, and
each cluster of the clustered set of customers is handled by one vehicle of the set of vehicles such that a demand of a subset of customers in the corresponding cluster does not exceed a capacity of the vehicle.

13. The one or more non-transitory computer-readable storage media according to claim 10, wherein
the vehicle routing problem is a vehicle routing problem with time-windows,
each of the set of customers has a demand that needs to be served in a time window, and
the clustering of the set of customers is further based the demand and the time window of each of the set of customers.

14. The one or more non-transitory computer-readable storage media according to claim 10, wherein
the vehicle routing problem is a pickup and delivery problem with time-windows,
each of set of customers has at least one of a pickup time window and a delivery time window, and
clustering of the set of customers is further based the pickup time window and the delivery time window.

15. The one or more non-transitory computer-readable storage media according to claim 10, wherein the operations further comprise:
controlling an execution of a first set of operations to construct the random-walk graph, wherein the first set of operations includes:
selecting a first customer from the set of customers,
selecting a second customer, different from the selected first customer, of the set of customers based on a pre-defined probability distribution corresponding to the selected first customer,
adding, in an undirected graph, a weighted edge between the selected first customer and the selected second customer, based on the received constraints, and
selecting, as the first customer, a third customer of the set of customers; and
obtaining the random-walk graph from the weighted undirected graph based on an iterative execution of the first set of operations for a first pre-determined number of iterations.

16. The one or more non-transitory computer-readable storage media according to claim 15, wherein the pre-defined probability distribution is at least one of a distance-based probability distribution or an angle-based probability distribution.

17. The one or more non-transitory computer-readable storage media according to claim 15, wherein the operations further comprise:
determining a Euclidean distance of the selected first customer from each remaining customer of the set of customers;
determining an angular distance of the selected first customer from each remaining customer of the set of customers; and
determining the pre-defined probability distribution, corresponding to the selected first customer, based on the determined Euclidean distance and the determined angular distance, wherein
the second customer is selected from the set of customers based on the determined pre-defined probability distribution.

18. The one or more non-transitory computer-readable storage media according to claim 10, wherein the operations further comprise:
determining a minimum number of cut-edges associated with the constructed random-walk graph, based on a number of nodes associated with the constructed random-walk graph, wherein
the graph partitioner is applied on the constructed random-walk graph based on the determined minimum number of cut-edges.

19. An electronic device, comprising:
a memory storing instructions; and
a processor, coupled to the memory, that executes the instructions to perform a process comprising:
receiving a set of constraints associated with a vehicle routing problem, wherein
the vehicle routing problem is an optimization problem whose goal is to determine a set of optimal routes, between a depot and a set of customers, for a delivery of a set of items using a set of vehicles, and
a total cost associated with the set of optimal routes corresponds to a minimum cost associated with a set of possible routes between the depot and the set of customers;
constructing the optimization problem based on the received set of constraints;
constructing a random-walk graph based on the constructed optimization problem and the received set of constraints;
applying a graph partitioner on the constructed random-walk graph;
clustering the set of customers based on the application of the graph partitioner on the constructed random-walk graph;
splitting the constructed optimization problem into a set of sub-problems, based on the clustering of the set of customers;
determining, using an annealer-based solver, an intermediate solution for each of the set of sub-problems to determine a set of routes associated with the corresponding sub-problem of the set of sub-problems;
combining the determined intermediate solution associated with each of the set of sub-problems to determine a final solution of the optimization problem based on the received set of constraints, wherein
the determined final solution is indicative of the set of optimal routes to be assigned to the set of vehicles; and
rendering the determined final solution of the optimization problem on a display device.

20. The electronic device according to claim 19, wherein the received set of constraints comprises at least one of a vehicle type constraint, an action type constraint, a distance validation constraint, a total time constraint, a task and amount matching validation constraint, a route end and stay validation constraint, a disabled route enforcement constraint, a demand constraint, an operation time constraint, a deadline constraint, a maximum load time constraint, a capacity computation constraint, and a vehicle capacity constraint.
